(19) United States
(12) Patent Application Publication
(10) Pub. No.: US 2025/0157412 A1
(43) Pub. Date: May 15, 2025

(54) GATE SIGNAL MASKING CIRCUIT, GATE DRIVER INCLUDING THE SAME AND DISPLAY APPARATUS INCLUDING THE SAME

(71) Applicant: Samsung Display Co., LTD., Yongin-si (KR)

(72) Inventors: KYUNGHO KIM, Yongin-si (KR); NAHYEON CHA, Yongin-si (KR); SANG YONG NO, Yongin-si (KR)

(21) Appl. No.: 18/946,738

(22) Filed: Nov. 13, 2024

(30) Foreign Application Priority Data
Nov. 15, 2023 (KR) 10-2023-0158661

(51) Int. Cl. G09G 3/3266; G09G 3/32

(52) U.S. Cl. CPC G09G 3/3266; G09G 3/32; G09G 2300/0426; G09G 2310/0267; G09G 2310/061; G09G 2330/021

(57) ABSTRACT

A gate signal masking circuit includes a first switching element including a control electrode connected to a masking node, a first electrode connected to a first node and a second electrode connected to a third node, a second switching element including a control electrode connected to a second node, a first electrode receiving a masking signal and a second electrode connected to a fourth node, a third switching element including a control electrode receiving a first signal, a first electrode connected to the fourth node and a second electrode connected to the masking node, a fourth switching element including a control electrode receiving a second signal, a first electrode connected to the masking node and a second electrode connected to a fifth node and a fifth switching element including a control electrode connected to the second node, an electrode connected to the fifth node and another electrode receiving a power.

This application claims priority to Korean Patent Application No. 10-2023-0158661, filed on Nov. 15, 2023, and all the benefits accruing therefrom under 35 U.S.C. § 119, the content of which in its entirety is herein incorporated by reference.

### BACKGROUND

### 1. Field

Embodiments of the invention relate to a gate signal masking circuit, a gate driver including the gate signal masking circuit, a display apparatus including the gate driver and an electronic apparatus including the gate driver. More particularly, embodiments of the invention relate to a gate signal masking circuit with reduced power consumption, a gate driver including the gate signal masking circuit, a display apparatus including the gate driver and an electronic apparatus including the gate driver.

### 2. Description of the Related Art

Generally, a display apparatus includes a display panel and a display panel driver. The display panel may include a plurality of gate lines, a plurality of data lines, a plurality of emission lines and a plurality of pixels. The display panel driver may include a gate driver, a data driver, an emission driver and a driving controller. The gate driver outputs gate signals to the gate lines. The data driver outputs data voltages to the data lines. The emission driver outputs emission signals to the emission lines. The driving controller controls the gate driver, the data driver and the emission driver.

When an image displayed on the display panel is a static image or the display panel is operated in always-on mode, a driving frequency of the display panel may be decreased to reduce a power consumption.

### SUMMARY

When a portion of an image displayed on a display panel is a static image and a portion of the image displayed on the display panel is a moving image, it may be desired to reduce a driving frequency of the portion of the display panel corresponding to the static image to further reduce the power consumption.

However, a stage of a gate driver typically receives an output of a previous stage as a carry signal to output the gate signal such that the driving frequency of only a portion of the display panel corresponding to the static image may not be decreased.

Embodiments of the invention provide a gate signal masking circuit enabling a multiple division of a driving frequency to reduce a power consumption of the display apparatus.

Embodiments of the invention also provide a gate driver including the gate signal masking circuit.

Embodiments of the invention also provide a display apparatus including the gate driver.

Embodiments of the invention also provide an electronic apparatus including the gate driver.

In an embodiment of a gate signal masking circuit according to the invention, the gate signal masking circuit includes a first switching element, a second switching element, a third switching element, a fourth switching element and a fifth switching element. In such an embodiment, the first switching element includes a control electrode connected to a masking control node, a first electrode connected to a first control node and a second electrode connected to a third control node. In such an embodiment, the second switching element includes a control electrode connected to a second control node, a first electrode which receives a masking power signal and a second electrode connected to a first intermediate node. In such an embodiment, the third switching element includes a control electrode which receives a first enable signal, a first electrode connected to the first intermediate node and a second electrode connected to the masking control node. In such an embodiment, the fourth switching element includes a control electrode which receives a second enable signal, a first electrode connected to the masking control node and a second electrode connected to a second intermediate node. In such an embodiment, the fifth switching element includes a control electrode connected to the second control node, a first electrode connected to the second intermediate node and a second electrode which receives a second low power voltage.

In an embodiment, the gate signal masking circuit may further include a sixth switching element including a control electrode connected to the third control node, a first electrode which receives a first clock signal and a second electrode connected to a gate output node, a seventh switching element including a control electrode connected to the second control node, a first electrode connected to the gate output node and a second electrode which receives a low power voltage and an eighth switching element including a control electrode connected to the second control node, a first electrode which receives the first clock signal and a second electrode connected to the third control node.

In an embodiment, the second low power voltage may be less than the low power voltage.

In an embodiment, the gate signal masking circuit may further include a first masking capacitor including a first electrode which receives the first clock signal and a second electrode connected to the third control node and a second masking capacitor including a first electrode connected to the masking control node and a second electrode which receives the low power voltage.

In an embodiment, the masking power signal may be a high power voltage which is a direct-current (DC) voltage.

In an embodiment, a high level of the first enable signal may be substantially the same as a high level of the second enable signal. A low level of the first enable signal may be different from a low level of the second enable signal.

In an embodiment, the high level of the first enable signal may be the high power voltage and the low level of the first enable signal may be a low power voltage greater than the second low power voltage. In such an embodiment, the high level of the second enable signal may be the high power voltage and the low level of the second enable signal may be the second low power voltage.

In an embodiment, the high level of the first enable signal may be the high power voltage and the low level of the first enable signal may be a low power voltage greater than the second low power voltage. In such an embodiment, the high level of the second enable signal may be the high power voltage and the low level of the second enable signal may be a third low power voltage different from the low power voltage and the second low power voltage.

In an embodiment, a high level of the first enable signal may be the high power voltage and a low level of the first enable signal may be the second low power voltage. A high level of the second enable signal may be the high power voltage and a low level of the second enable signal may be the second low power voltage.

In an embodiment, a high level of the first enable signal may be the high power voltage and a low level of the first enable signal may be a third low power voltage different from the second low power voltage. In such an embodiment, a high level of the second enable signal may be the high power voltage and a low level of the second enable signal is the third low power voltage.

In an embodiment, the first switching element may further include an additional control electrode connected to the masking control node.

In an embodiment, the fifth switching element may further include an additional control electrode connected to the second control node.

In an embodiment, the masking power signal may be a clock signal having a high level when the first enable signal changes from an active level to an inactive level and when the first enable signal changes from the inactive level to the active level.

In an embodiment, when the first enable signal has an inactive level in all periods in which a signal of the second control node has an active level, the gate signal masking circuit may output a gate pulse.

In an embodiment, when the first enable signal has an active level in all periods in which a signal of the second control node has an active level, the gate signal masking circuit may not output a gate pulse.

In an embodiment, when the first enable signal is changed from an inactive level to an active level during a period in which a signal of the second control node has an active level, the gate signal masking circuit may output a gate pulse.

In an embodiment, when the first enable signal is changed from an active level to an inactive level during a period in which a signal of the second control node has an active level, the gate signal masking circuit may not output a gate pulse.

In an embodiment of a gate driver according to the invention, the gate driver includes a carry generator and a gate signal masking circuit. In such an embodiment, the carry generator generates a carry signal based on a previous carry signal, a first clock signal, a second clock signal and a low power voltage. In such an embodiment, the gate signal masking circuit is connected to the carry generator. In such an embodiment, the carry generator includes a pull-up switching element which pulls up the carry signal in response to a signal of a first control node and a pull-down switching element which pulls down the carry signal in response to a signal of a second control node. In such an embodiment, the gate signal masking circuit outputs a gate pulse or not to output the gate pulse based on the signal of the second control node, a first enable signal and a second enable signal.

In an embodiment, the gate signal masking circuit may include a first switching element including a control electrode connected to a masking control node, a first electrode connected to the first control node and a second electrode connected to a third control node, a second switching element including a control electrode connected to the second control node, a first electrode which receives a masking power signal and a second electrode connected to a first intermediate node, a third switching element including a control electrode which receives the first enable signal, a first electrode connected to the first intermediate node and a second electrode connected to the masking control node, a fourth switching element including a control electrode which receives the second enable signal, a first electrode connected to the masking control node and a second electrode connected to a second intermediate node and a fifth switching element including a control electrode connected to the second control node, a first electrode connected to the second intermediate node and a second electrode which receives a second low power voltage.

In an embodiment, the carry generator may include a first gate switching element including a control electrode which receives the first clock signal, a first electrode which receives the previous carry signal and a second electrode connected to a first node, a second gate switching element including a control electrode connected to the second control node, a first electrode which receives the second clock signal and a second electrode connected to a fifth node, a third gate switching element including a control electrode which receives the first clock signal, a first electrode connected to a second node and a second electrode which receives the low power voltage, a fourth gate switching element including a control electrode which receives the low power voltage, a first electrode connected to the second node and a second electrode connected to a third node, a fifth gate switching element including a control electrode connected to the second control node, a first electrode which receives the first clock signal and a second electrode connected to the second node, a sixth gate switching element including a control electrode connected to the third node, a first electrode which receives the second clock signal and a second electrode connected to a third intermediate node, a seventh gate switching element including a control electrode connected to the third node, a first electrode connected to a fourth node and a second electrode connected to the third intermediate node, an eighth gate switching element including a control electrode which receives the second clock signal, a first electrode connected to the fourth node and a second electrode connected to the first control node, a ninth gate switching element including a control electrode connected to the first control node, a first electrode which receives the first clock signal and a second electrode connected to a carry output node, a tenth gate switching element including a control electrode connected to the second control node, a first electrode connected to the carry output node and a second electrode which receives the low power voltage, an eleventh gate switching element including a control electrode which receives the low power voltage, a first electrode connected to the first node and a second electrode connected to the second control node and a fourteenth gate switching element including a control electrode connected to the second control node, a first electrode which receives the first clock signal and a second electrode connected to the first control node. In such an embodiment, the ninth gate switching element may be the pull-up switching element, and the tenth gate switching element may be the pull-down switching element.

In an embodiment, the carry generator may further include a twelfth gate switching element including a control electrode which receives a reset signal, a first electrode which receives the first clock signal and a second electrode connected to the first node and a thirteenth gate switching element including a control electrode which receives the reset signal, a first electrode connected to the first control node and a second electrode connected to the low power voltage.

In an embodiment, the carry generator may further include a first capacitor including a first electrode which receives the first clock signal and a second electrode connected to the first control node, a second capacitor including a first electrode connected to the third node and a second electrode connected to the fourth node, a third capacitor including a first electrode connected to the fifth node and a second electrode connected to the second control node and a fourth capacitor including a first electrode connected to the carry output node and a second electrode which receives the low power voltage.

In an embodiment, the control electrode of the tenth gate switching element and the control electrode of the fourteenth gate switching element may be connected to the control electrode of the seventh switching element and the control electrode of the eighth switching element.

In an embodiment, the control electrode of the ninth gate switching element may be connected to the first electrode of the first switching element.

In an embodiment of a display apparatus according to the invention, the display apparatus includes a display panel, a gate driver and a data driver. The display panel includes a pixel. In such an embodiment, the gate driver outputs a gate signal to the pixel. In such an embodiment, the data driver outputs a data voltage to the pixel. In such an embodiment, the gate driver includes a carry generator which generates a carry signal based on a previous carry signal, a first clock signal, a second clock signal and a low power voltage and a gate signal masking circuit connected to the carry generator. In such an embodiment, the carry generator includes a pull-up switching element which pulls up the carry signal in response to a signal of a first control node and a pull-down switching element which pulls down the carry signal in response to a signal of a second control node. In such an embodiment, the gate signal masking circuit outputs a gate pulse or does not output the gate pulse based on the signal of the second control node, a first enable signal and a second enable signal.

In an embodiment of an electronic apparatus according to the invention, the electronic apparatus includes a display panel, a gate driver, a data driver, a driving controller and a processor. The display panel includes a pixel. In such an embodiment, the gate driver outputs a gate signal to the pixel. In such an embodiment, the data driver outputs a data voltage to the pixel. In such an embodiment, the driving controller controls the gate driver and the data driver. In such an embodiment, the processor outputs input image data and an input control signal to the driving controller. In such an embodiment, the gate driver includes a carry generator which generates a carry signal based on a previous carry signal, a first clock signal, a second clock signal and a low power voltage and a gate signal masking circuit connected to the carry generator. In such an embodiment, the carry generator includes a pull-up switching element which pulls up the carry signal in response to a signal of a first control node and a pull-down switching element which pulls down the carry signal in response to a signal of a second control node. In such an embodiment, the gate signal masking circuit outputs a gate pulse or does not output the gate pulse based on the signal of the second control node, a first enable signal and a second enable signal.

According to embodiments of the gate signal masking circuit, the gate driver, the display apparatus and the electronic apparatus, the output of the gate signal may be controlled based on the signal of the second control node which is applied to the pull-down switching element which pulls down the carry signal, the first enable signal and the second enable signal such that the multiple division of the driving frequency may be effectively performed.

In such embodiments, through the multiple division of the driving frequency, the power consumption of the display apparatus may be effectively reduced.

In such embodiments, the signal of the masking control node may be determined based on the signal of the second control node such that the reliability of the gate signal masking circuit may be enhanced by decreasing the low level of the signal of the masking control node.

In such embodiments, the second low power voltage less than the low power voltage is applied to the second electrode of the fifth switching element such that the reliability of the gate signal masking circuit may be enhanced by decreasing the low level of the signal of the masking control node.

In such embodiments, the first switching element may further include the additional control electrode connected to the masking control node such that the reliability of the gate signal masking circuit may be enhanced by decreasing the low level of the signal of the third control node.

In such embodiments, the fifth switching element may further include the additional control electrode connected to the second control node such that the reliability of the gate signal masking circuit may be enhanced by decreasing the low level of the signal of the masking control node.

### BRIEF DESCRIPTION OF THE DRAWINGS

The above and other features of embodiments of the invention will become more apparent by describing in detailed embodiments thereof with reference to the accompanying drawings, in which:

FIG. 1 is a block diagram illustrating a display apparatus according to an embodiment of the invention;

FIG. 2 is a circuit diagram illustrating an example of a pixel of the display panel of FIG. 1;

FIG. 3 is a circuit diagram illustrating an example of a pixel of the display panel of FIG. 1;

FIG. 4 is a circuit diagram illustrating an example of a pixel of the display panel of FIG. 1;

FIG. 5 is a conceptual diagram illustrating an embodiment of a gate driver of FIG. 1;

FIG. 6 is a conceptual diagram illustrating a first enable signal and a second enable signal applied to the gate driver of FIG. 1 according to driving frequencies of portions of the display panel of FIG. 1;

FIG. 7 is a circuit diagram illustrating an embodiment of a carry generator and a gate signal masking circuit of the gate driver of FIG. 1;

FIG. 8 is a signal timing diagram illustrating input signals, node signals and an output signal of the carry generator of FIG. 7;

FIG. 9 is a circuit diagram illustrating an operation of the carry generator of FIG. 7 in a first time point of FIG. 8;

FIG. 10 is a circuit diagram illustrating an operation of the carry generator of FIG. 7 in a second time point of FIG. 8;

FIG. 11 is a circuit diagram illustrating an operation of the carry generator of FIG. 7 in a third time point of FIG. 8;

FIG. 12 is a circuit diagram illustrating an operation of the carry generator of FIG. 7 in a fourth time point of FIG. 8;

FIG. 13 is a circuit diagram illustrating an operation of the carry generator of FIG. 7 in a fifth time point of FIG. 8;

FIG. 14 is a signal timing diagram illustrating a signal of a masking control node and a signal of the second control node of the gate signal masking circuit of FIG. 7;

FIG. 15 is a table illustrating a state of the signal of the masking control node according to an input signal of the gate signal masking circuit of FIG. 7;

FIG. 16 is a signal timing diagram illustrating an output signal of the gate signal masking circuit according to the input signal of the gate signal masking circuit of FIG. 7;

FIG. 17 is a signal timing diagram illustrating input signals, a node signal and output signals of the carry generator and the gate signal masking circuit of FIG. 7 in a first case;

FIG. 18 is a signal timing diagram illustrating input signals, a node signal and output signals of the carry generator and the gate signal masking circuit of FIG. 7 in a second case;

FIG. 19 is a signal timing diagram illustrating input signals, a node signal and output signals of the carry generator and the gate signal masking circuit of FIG. 7 in a third case;

FIG. 20 is a signal timing diagram illustrating input signals, a node signal and output signals of the carry generator and the gate signal masking circuit of FIG. 7 in a fourth case;

FIG. 21A is a signal timing diagram illustrating examples of a waveform of a first enable signal and a waveform of a second enable signal applied to the gate signal masking circuit of FIG. 7;

FIG. 21B is a signal timing diagram illustrating examples of a waveform of a first enable signal and a waveform of a second enable signal applied to the gate signal masking circuit of FIG. 7;

FIG. 21C is a signal timing diagram illustrating examples of a waveform of a first enable signal and a waveform of a second enable signal applied to the gate signal masking circuit of FIG. 7;

FIG. 21D is a signal timing diagram illustrating examples of a waveform of a first enable signal and a waveform of a second enable signal applied to the gate signal masking circuit of FIG. 7;

FIG. 22 is a signal timing diagram illustrating a carry signal and a signal of the second control node of the carry generator of FIG. 7;

FIG. 23 is a signal timing diagram illustrating a signal of a masking control node of a gate signal masking circuit according to a comparative embodiment and an embodiment of the invention;

FIG. 24 is a circuit diagram illustrating a carry generator and a gate signal masking circuit of the gate driver according to an embodiment of the invention;

FIG. 25 is a circuit diagram illustrating a carry generator and a gate signal masking circuit of the gate driver according to an embodiment of the invention;

FIG. 26 is a circuit diagram illustrating a carry generator and a gate signal masking circuit of the gate driver according to an embodiment of the invention;

FIG. 27 is a circuit diagram illustrating a carry generator and a gate signal masking circuit of a gate driver according to an embodiment of the invention;

FIG. 28 is a signal timing diagram illustrating a signal of a masking control node and a signal of a second control node of the gate signal masking circuit of FIG. 27;

FIG. 29 is a block diagram illustrating an electronic apparatus according to an embodiment of the invention; and

FIG. 30 is a diagram illustrating an embodiment in which the electronic apparatus of FIG. 29 is implemented as a smart phone.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, embodiments of the invention will be described in detail with reference to the accompanying drawings.

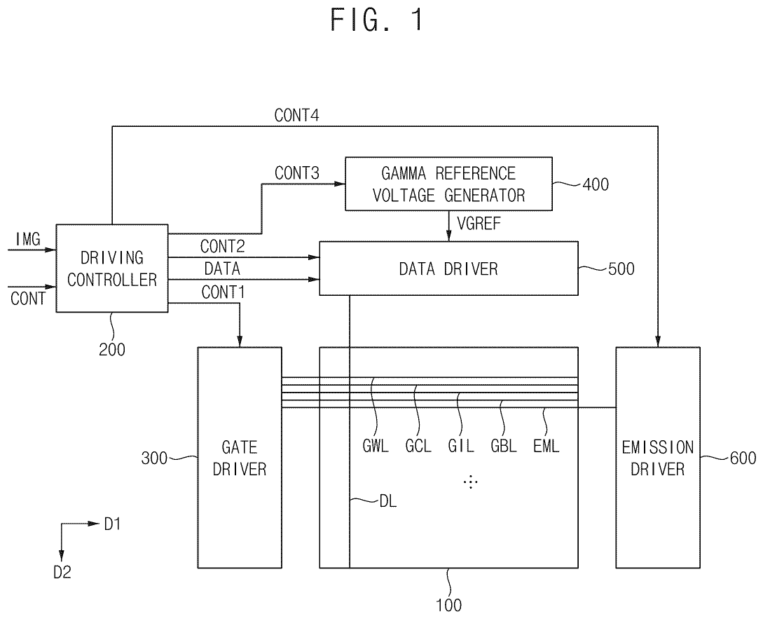

FIG. 1 is a block diagram illustrating a display apparatus according to an embodiment of the invention.

Referring to FIG. 1, an embodiment of the display apparatus includes a display panel 100 and a display panel driver. The display panel driver includes a driving controller 200, a gate driver 300, a gamma reference voltage generator 400, a data driver 500 and an emission driver 600.

The display panel 100 has a display region on which an image is displayed and a peripheral region adjacent to the display region.

The display panel 100 includes a plurality of gate lines GWL, GCL, GIL and GBL, a plurality of data lines DL, a plurality of emission lines EML and a plurality of pixels electrically connected to the gate lines GWL, GCL, GIL and GBL, the data lines DL and the emission lines EML. The gate lines GWL, GCL, GIL and GBL may extend in a first direction D1, the data lines DL may extend in a second direction D2 crossing the first direction D1 and the emission lines EML may extend in the first direction D1.

The driving controller 200 receives input image data IMG and an input control signal CONT from an external apparatus (e.g. a processor). In an embodiment, for example, the input image data IMG may include red image data, green image data and blue image data. The input image data IMG may further include white image data. In another embodiment, for example, the input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 generates a first control signal CONT1, a second control signal CONT2, a third control signal CONT3, a fourth control signal CONT4 and a data signal DATA based on the input image data IMG and the input control signal CONT.

The driving controller 200 generates the first control signal CONT1 for controlling an operation of the gate driver 300 based on the input control signal CONT, and outputs the first control signal CONT1 to the gate driver 300. The first control signal CONT1 may include a vertical start signal and a gate clock signal.

The driving controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 generates the data signal DATA based on the input image data IMG. The driving controller 200 outputs the data signal DATA to the data driver 500.

The driving controller 200 generates the third control signal CONT3 for controlling an operation of the gamma reference voltage generator 400 based on the input control signal CONT, and outputs the third control signal CONT3 to the gamma reference voltage generator 400.

The driving controller 200 generates the fourth control signal CONT4 for controlling an operation of the emission driver 600 based on the input control signal CONT, and outputs the fourth control signal CONT4 to the emission driver 600.

The gate driver 300 generates gate signals driving the gate lines GWL, GCL, GIL and GBL in response to the first control signal CONT1 received from the driving controller 200. The gate driver 300 may sequentially output the gate signals to the gate lines GWL, GCL, GIL and GBL.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to a level of the data signal DATA.

In an embodiment, the gamma reference voltage generator 400 may be disposed in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages having an analog type using the gamma reference voltages VGREF. The data driver 500 outputs the data voltages to the data lines DL.

The emission driver 600 generates emission signals to drive the emission lines EML in response to the fourth control signal CONT4 received from the driving controller 200. The emission driver 600 may output the emission signals to the emission lines EML.

Although an embodiment where the gate driver 300 is disposed at a first side of the display panel 100 and the emission driver 600 is disposed at a second side of the display panel 100 opposite to the first side is shown in FIG. 1 for convenience of illustration and description, the invention may not be limited thereto. In another embodiment, for example, both of the gate driver 300 and the emission driver 600 may be disposed at the first side of the display panel 100. In another embodiment, for example, the gate driver 300 and the emission driver 600 may be disposed at both sides of the display panel 100. In another embodiment, for example, the gate driver 300 and the emission driver 600 may be integrally formed.

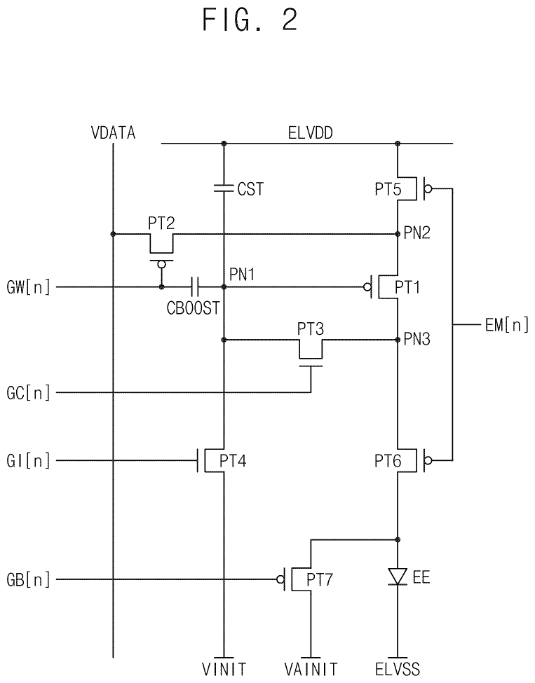

FIG. 2 is a circuit diagram illustrating an example of a pixel of the display panel 100 of FIG. 1.

Referring to FIGS. 1 and 2, an embodiment of the display panel 100 includes a plurality of pixels. Each of the pixels includes a light emitting element EE.

A pixel receives a data writing gate signal GW, a compensation gate signal GC, a data initialization gate signal GI, a light emitting element initialization gate signal GB, the data voltage VDATA and the emission signal EM, and the light emitting element EE of the pixel emits light corresponding to the level of the data voltage VDATA to display the image.

In an embodiment, the pixel may include a pixel switching element of a first type and a pixel switching element of a second type different from the first type. In an embodiment, for example, the pixel switching element of the first type may be a polysilicon thin film transistor. In an embodiment, for example, the pixel switching element of the first type may be a low temperature polysilicon (LTPS) thin film transistor. In an embodiment, for example, the pixel switching element of the second type may be an oxide thin film transistor. In an embodiment, for example, the pixel switching element of the first type may be a P-type transistor and the pixel switching element of the second type may be an N-type transistor.

In an embodiment, some of the pixel switching elements may be the oxide thin film transistors and other pixel switching elements may be the polysilicon thin film transistors, but the invention may not be limited thereto. Features of embodiments of the invention described herein may be applied to the pixel including only the oxide thin film transistors. In an embodiment, some of the pixel switching elements may be the N-type transistors and other pixel switching elements may be the P-type transistors, but the invention may not be limited thereto. Features of embodiments of the invention described herein may be applied to the pixel including only the N-type transistors.

In an embodiment, as shown in FIG. 2, at least one of the pixels may include first to seventh pixel switching elements PT1 to PT7 and the light emitting element EE.

The first pixel switching element PT1 may include a control electrode connected to a first pixel node PN1, a first electrode connected to a second pixel node PN2 and a second electrode connected to a third pixel node PN3. The second pixel switching element PT2 may include a control electrode that receives the data writing gate signal GW[n], a first electrode that receives the data voltage VDATA and a second electrode connected to the second pixel node PN2. The third pixel switching element PT3 may include a control electrode that receives the compensation gate signal GC[n], a first electrode connected to the first pixel node PN1 and a second electrode connected to the third pixel node PN3. The fourth pixel switching element PT4 may include a control electrode that receives the data initialization gate signal GI[n], a first electrode that receives an initialization voltage VINIT and a second electrode connected to the first pixel node PN1. The fifth pixel switching element PT5 may include a control electrode that receives the emission signal EM[n], a first electrode that receives a pixel high power voltage ELVDD and a second electrode connected to the second pixel node PN2. The sixth pixel switching element PT6 may include a control electrode that receives the emission signal EM[n], a first electrode connected to the third pixel node PN3 and a second electrode connected to an anode electrode of the light emitting element EE. The seventh pixel switching element PT7 may include a control electrode that receives the light emitting element initialization gate signal GB[n], a first electrode that receives a light emitting element initialization voltage VAINIT and a second electrode connected to the anode electrode of the light emitting element EE. The light emitting element EE may include the anode electrode and a cathode electrode that receives a pixel low power voltage ELVSS.

The pixel may further include a storage capacitor CST including a first electrode that receives the pixel high power voltage ELVDD and a second electrode connected to the first pixel node PN1 and a boosting capacitor CBOOST including a first electrode that receives the data writing gate signal GW[n] and a second electrode connected to the first pixel node PN1.

The signal output from a gate signal masking circuit of the gate driver 300 may be the compensation gate signal GC[n].

A driving current may flow through the fifth pixel switching element PT5, the first pixel switching element PT1 and the sixth pixel switching element PT6 to drive the light emitting element EE. An intensity of the driving current may be determined by the level of the data voltage VDATA. A luminance of the light emitting element EE may be determined by the intensity of the driving current.

In an embodiment, when the image displayed on the display panel 100 is a static image or the display panel is operated in always-on mode, a driving frequency of the display panel 100 may be decreased to reduce a power consumption. In a case where all of the switching elements of the pixel of the display panel 100 are polysilicon thin film transistor, a flicker may occur due to a leakage current of the pixel switching element in the low frequency driving mode. Thus, some of the pixel switching elements may be designed using the oxide thin film transistors. In an embodiment, the third pixel switching element PT3 and the fourth pixel switching element PT4 may be the oxide thin film transistors. In such an embodiment, the first pixel switching element PT1, the second pixel switching element PT2, the fifth pixel switching element PT5, the sixth pixel switching element PT6 and the seventh pixel switching element PT7 may be the polysilicon thin film transistors.

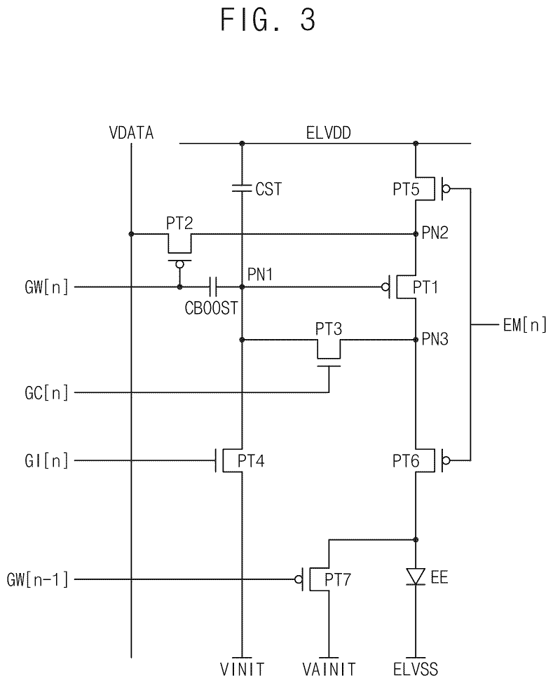

FIG. 3 is a circuit diagram illustrating an example of a pixel of the display panel 100 of FIG. 1.

Referring to FIGS. 1 and 3, an embodiment of the display panel 100 includes a plurality of pixels. Each of the pixels includes a light emitting element EE.

The pixel receives a data writing gate signal GW, a compensation gate signal GC, a data initialization gate signal GI, a light emitting element initialization gate signal GB, the data voltage VDATA and the emission signal EM, and the light emitting element EE of the pixel emits light corresponding to the level of the data voltage VDATA to display the image.

In an embodiment, the pixel may include a pixel switching element of a first type and a pixel switching element of a second type different from the first type. In an embodiment, for example, the pixel switching element of the first type may be a polysilicon thin film transistor. In an embodiment, for example, the pixel switching element of the first type may be a low temperature polysilicon (LTPS) thin film transistor. In an embodiment, for example, the pixel switching element of the second type may be an oxide thin film transistor. In an embodiment, for example, the pixel switching element of the first type may be a P-type transistor and the pixel switching element of the second type may be an N-type transistor.

In an embodiment, as shown in FIG. 3, at least one of the pixels may include first to seventh pixel switching elements PT1 to PT7 and the light emitting element EE.

The first pixel switching element PT1 may include a control electrode connected to a first pixel node PN1, a first electrode connected to a second pixel node PN2 and a second electrode connected to a third pixel node PN3. The second pixel switching element PT2 may include a control electrode that receives the data writing gate signal GW[n], a first electrode that receives the data voltage VDATA and a second electrode connected to the second pixel node PN2. The third pixel switching element PT3 may include a control electrode that receives the compensation gate signal GC[n], a first electrode connected to the first pixel node PN1 and a second electrode connected to the third pixel node PN3. The fourth pixel switching element PT4 may include a control electrode that receives the data initialization gate signal GI[n], a first electrode that receives an initialization voltage VINIT and a second electrode connected to the first pixel node PN1. The fifth pixel switching element PT5 may include a control electrode that receives the emission signal EM[n], a first electrode that receives a pixel high power voltage ELVDD and a second electrode connected to the second pixel node PN2. The sixth pixel switching element PT6 may include a control electrode that receives the emission signal EM[n], a first electrode connected to the third pixel node PN3 and a second electrode connected to an anode electrode of the light emitting element EE. The seventh pixel switching element PT7 may include a control electrode that receives the light emitting element initialization gate signal GB[n], a first electrode that receives a light emitting element initialization voltage VAINIT and a second electrode connected to the anode electrode of the light emitting element EE. The light emitting element EE may include the anode electrode and a cathode electrode that receives a pixel low power voltage ELVSS.

The pixel may further include a storage capacitor CST including a first electrode that receives the pixel high power voltage ELVDD and a second electrode connected to the first pixel node PN1 and a boosting capacitor CBOOST including a first electrode that receives the data writing gate signal GW[n] and a second electrode connected to the first pixel node PN1.

The signal output from a gate signal masking circuit of the gate driver 300 may be the compensation gate signal GC[n].

In an embodiment, as shown in FIG. 3, the light emitting element initialization gate signal GB[n] may be a data writing gate signal GW[n−1] of a previous stage. In such an embodiment where the data writing gate signal GW[n−1] of the previous stage is used as the light emitting element initialization gate signal GB[n] of the present stage, a part of the gate signal generating circuit of the gate driver 300 may be omitted. Thus, the manufacturing cost of the display apparatus may be reduced and the dead space of the display apparatus may be reduced.

In an embodiment, the third pixel switching element PT3 and the fourth pixel switching element PT4 may be the oxide thin film transistors. In such an embodiment, the first pixel switching element PT1, the second pixel switching element PT2, the fifth pixel switching element PT5, the sixth pixel switching element PT6 and the seventh pixel switching element PT7 may be the polysilicon thin film transistors.

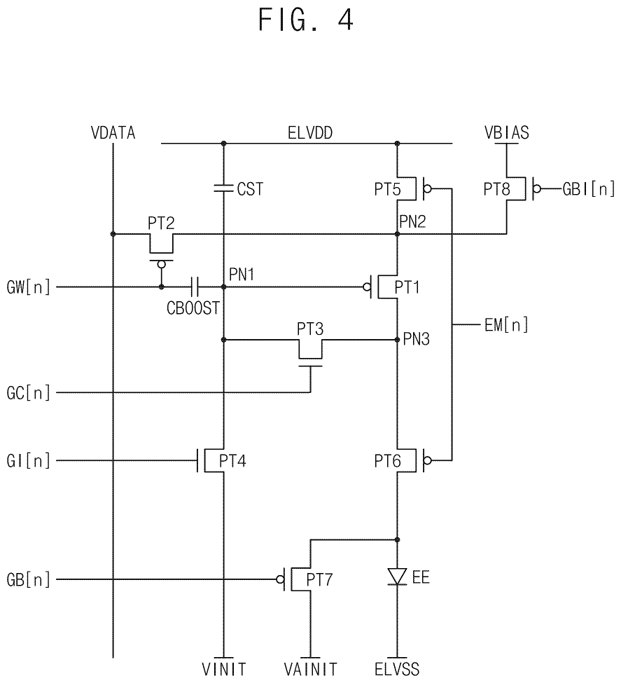

FIG. 4 is a circuit diagram illustrating an example of a pixel of the display panel 100 of FIG. 1.

Referring to FIGS. 1 and 4, an embodiment of the display panel 100 includes a plurality of pixels. Each of the pixels includes a light emitting element EE.

The pixel receives a data writing gate signal GW, a compensation gate signal GC, a data initialization gate signal GI, a light emitting element initialization gate signal GB, a bias gate signal GBI, the data voltage VDATA and the emission signal EM and the light emitting element EE of the pixel emits light corresponding to the level of the data voltage VDATA to display the image.

In an embodiment, as shown in FIG. 4, the pixel may include a pixel switching element of a first type and a pixel switching element of a second type different from the first type. In an embodiment, for example, the pixel switching element of the first type may be a polysilicon thin film transistor. In an embodiment, for example, the pixel switching element of the first type may be a low temperature polysilicon (LTPS) thin film transistor. In an embodiment, for example, the pixel switching element of the second type may be an oxide thin film transistor. In an embodiment, for example, the pixel switching element of the first type may be a P-type transistor and the pixel switching element of the second type may be an N-type transistor.

At least one of the pixels may include first to eighth pixel switching elements PT1 to PT8 and the light emitting element EE.

The first pixel switching element PT1 may include a control electrode connected to a first pixel node PN1, a first electrode connected to a second pixel node PN2 and a second electrode connected to a third pixel node PN3. The second pixel switching element PT2 may include a control electrode that receives the data writing gate signal GW[n], a first electrode that receives the data voltage VDATA and a second electrode connected to the second pixel node PN2. The third pixel switching element PT3 may include a control electrode that receives the compensation gate signal GC[n], a first electrode connected to the first pixel node PN1 and a second electrode connected to the third pixel node PN3. The fourth pixel switching element PT4 may include a control electrode that receives the data initialization gate signal GI[n], a first electrode that receives an initialization voltage VINIT and a second electrode connected to the first pixel node PN1. The fifth pixel switching element PT5 may include a control electrode that receives the emission signal EM[n], a first electrode that receives a pixel high power voltage ELVDD and a second electrode connected to the second pixel node PN2. The sixth pixel switching element PT6 may include a control electrode that receives the emission signal EM[n], a first electrode connected to the third pixel node PN3 and a second electrode connected to an anode electrode of the light emitting element EE. The seventh pixel switching element PT7 may include a control electrode that receives the light emitting element initialization gate signal GB[n], a first electrode that receives a light emitting element initialization voltage VAINIT and a second electrode connected to an anode electrode of the light emitting element EE. The eighth pixel switching element PT8 may include a control electrode that receives the bias gate signal GBI[n], a first electrode that receives a bias voltage VBIAS and a second electrode connected to the second pixel node PN2. The light emitting element EE may include the anode electrode and a cathode electrode that receives a pixel low power voltage ELVSS.

The pixel may further include a storage capacitor CST including a first electrode that receives the pixel high power voltage ELVDD and a second electrode connected to the first pixel node PN1 and a boosting capacitor CBOOST including a first electrode that receives the data writing gate signal GW[n] and a second electrode connected to the first pixel node PN1.

The signal outputted from a gate signal masking circuit of the gate driver 300 may be the compensation gate signal GC[n].

In an embodiment, the third pixel switching element PT3 and the fourth pixel switching element PT4 may be the oxide thin film transistors. In such an embodiment, the first pixel switching element PT1, the second pixel switching element PT2, the fifth pixel switching element PT5, the sixth pixel switching element PT6, the seventh pixel switching element PT7 and the eighth pixel switching element PT8 may be the polysilicon thin film transistors.

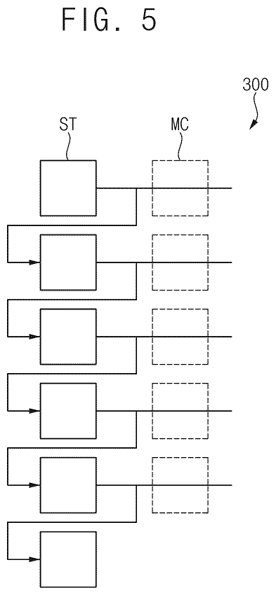

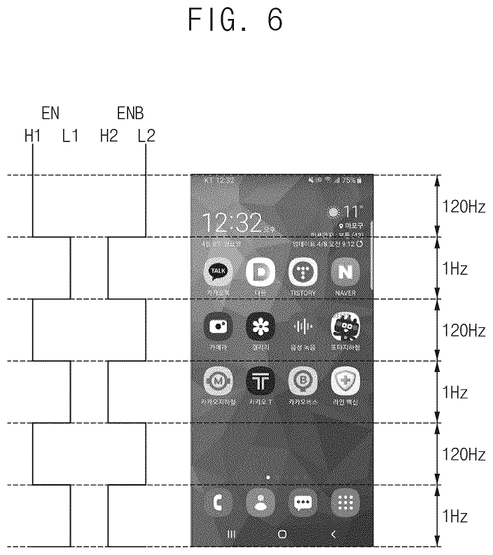

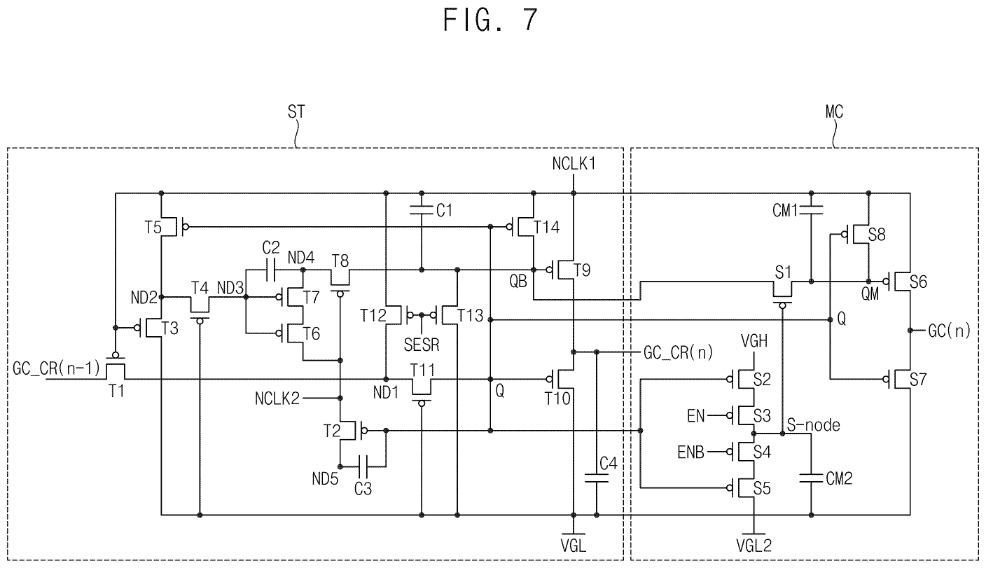

FIG. 5 is a conceptual diagram illustrating an embodiment of the gate driver 300 of FIG. 1. FIG. 6 is a conceptual diagram illustrating a first enable signal EN and a second enable signal ENB applied to the gate driver 300 of FIG. 1 according to driving frequencies of portions of the display panel 100 of FIG. 1. FIG. 7 is a circuit diagram illustrating an embodiment of a carry generator ST and a gate signal masking circuit MC of the gate driver 300 of FIG. 1.

Referring to FIGS. 1 to 7, an embodiment of the gate driver 300 may include the carry generator ST that generates a carry signal GC_CR(n) based on a previous carry signal GC_CR(n−1), a first clock signal NCLK1, a second clock signal NCLK2 and a low power voltage VGL, and a gate signal masking circuit MC connected to the carry generator ST.

The gate signal masking circuit MC may output or not output a gate pulse based on the signal of the second control node Q of the carry generator ST, the first enable signal EN and the second enable signal ENB.

In an embodiment, for example, when the first enable signal EN has a high level H1 and the second enable signal ENB has a low level L2, the gate signal masking circuit MC may output the gate pulse.

In an embodiment, for example, when the first enable signal EN has a low level L1 and the second enable signal ENB has a high level H2, the gate signal masking circuit MC may not output the gate pulse.

In an embodiment, as shown in FIG. 6, the gate driver 300 may output the gate pulse at a high frequency (e.g., 120 Hz) for a portion of the display panel 100 where a high frequency driving is performed, and may output a gate pulse at a low frequency (e.g., 1 Hz) for a portion of the display panel 100 where a low frequency driving is performed based on the first enable signal EN and the second enable signal ENB.

The gate signal masking circuit MC may mask an output of the gate pulse to output the gate pulse in the low frequency (e.g., 1 Hz). The carry generator ST transfers the carry signal to a next stage regardless of the operation of the gate signal masking circuit MC that masks the output of the gate pulse such that the gate driver 300 may effectively perform the multiple division of the driving frequency.

In an embodiment, as shown in FIG. 7, the gate signal masking circuit MC may include first to fifth switching elements S1 to S5. The first switching element S1 may include a control electrode connected to a masking control node S-node, a first electrode connected to a first control node QB and a second electrode connected to a third control node QM. The second switching element S2 may include a control electrode connected to a second control node Q, a first electrode that receives a masking power signal and a second electrode connected to a first intermediate node. The third switching element S3 may include a control electrode that receives the first enable signal EN, a first electrode connected to the first intermediate node and a second electrode connected to the masking control node S-node. The fourth switching element S4 may include a control electrode that receives the second enable signal ENB, a first electrode connected to the masking control node S-node and a second electrode connected to a second intermediate node. The fifth switching element S5 may include a control electrode connected to the second control node Q, a first electrode connected to the second intermediate node and a second electrode that receives a second low power voltage VGL2.

In such an embodiment, the gate signal masking circuit MC may further include a sixth to eighth switching elements S6 to S8. The sixth switching element S6 may include a control electrode connected to the third control node QM, a first electrode that receives the first clock signal NCLK1 and a second electrode connected to a gate output node. The seventh switching element S7 may include a control electrode connected to the second control node Q, a first electrode connected to the gate output node and a second electrode that receives a low power voltage VGL. The eighth switching element S8 may include a control electrode connected to the second control node Q, a first electrode that receives the first clock signal NCLK1 and a second electrode connected to the third control node QM.

In an embodiment, the second low power voltage VGL2 may be less than the low power voltage VGL. The second low power voltage VGL2 may be a direct-current (DC) voltage. The low power voltage VGL may be a DC voltage.

The gate signal masking circuit MC may further include a first masking capacitor CM1 including a first electrode that receives the first clock signal NCLK1 and a second electrode connected to the third control node QM and a second masking capacitor CM2 including a first electrode connected to the masking control node S-node and a second electrode that receives the low power voltage VGL.

In an embodiment, the masking power signal may be a high power voltage VGH. The high power voltage VGH may be a DC voltage.

The carry generator ST may include first to eleventh gate switching elements T1 to T11 and a fourteenth gate switching element T14.

The first gate switching element T1 may include a control electrode that receives the first clock signal NCLK1, a first electrode that receives the previous carry signal GC_CR(n−1) and a second electrode connected to a first node ND1. The second gate switching element T2 may include a control electrode connected to the second control node Q, a first electrode that receives the second clock signal NCLK2 and a second electrode connected to a fifth node ND5. The third gate switching element T3 may include a control electrode that receives the first clock signal NCLK1, a first electrode connected to a second node ND2 and a second electrode that receives the low power voltage VGL. The fourth gate switching element T4 may include a control electrode that receives the low power voltage VGL, a first electrode connected to the second node ND2 and a second electrode connected to a third node ND3. The fifth gate switching element T5 may include a control electrode connected to the second control node Q, a first electrode that receives the first clock signal NCLK1 and a second electrode connected to the second node ND2. The sixth gate switching element T6 may include a control electrode connected to the third node ND3, a first electrode that receives the second clock signal NCLK2 and a second electrode connected to a third intermediate node. The seventh gate switching element T7 may include a control electrode connected to the third node ND3, a first electrode connected to a fourth node ND4 and a second electrode connected to the third intermediate node. The eighth gate switching element T8 may include a control electrode that receives the second clock signal NCLK2, a first electrode connected to the fourth node ND4 and a second electrode connected to the first control node QB. The ninth gate switching element T9 may include a control electrode connected to the first control node QB, a first electrode that receives the first clock signal NCLK1 and a second electrode connected to a carry output node. The tenth gate switching element T10 may include a control electrode connected to the second control node Q, a first electrode connected to the carry output node and a second electrode that receives the low power voltage VGL. The eleventh gate switching element T11 may include a control electrode that receives the low power voltage VGL, a first electrode connected to the first node ND1 and a second electrode connected to the second control node Q. The fourteenth gate switching element T14 may include a control electrode connected to the second control node Q, a first electrode that receives the first clock signal NCLK1 and a second electrode connected to the first control node QB.

The ninth gate switching element T9 may be a pull-up switching element that pulls up the carry signal GC_CR(n) in response to the signal of the first control node QB. The tenth gate switching element T10 may be a pull-down switching element that pulls down the carry signal GC_CR(n) in response to the signal of the second control node Q.

The carry generator ST may further include a twelfth gate switching element T12 including a control electrode that receives a reset signal SESR, a first electrode that receives the first clock signal NCLK1 and a second electrode connected to the first node ND1 and a thirteenth gate switching element T13 including a control electrode that receives the reset signal SESR, a first electrode connected to the first control node QB and a second electrode connected to the low power voltage VGL.

The carry generator ST may further include a first capacitor C1 including a first electrode that receives the first clock signal NCLK1 and a second electrode connected to the first control node QB, a second capacitor C2 including a first electrode connected to the third node ND3 and a second electrode connected to the fourth node ND4 and a third capacitor C3 including a first electrode connected to the fifth node ND5 and a second electrode connected to the second control node Q. The carry generator ST may further include a fourth capacitor C4 including a first electrode connected to the carry output node and a second electrode that receives the low power voltage VGL.

In an embodiment, for example, the control electrode of the tenth gate switching element T10 of the carry generator ST and the control electrode of the fourteenth gate switching element T14 of the carry generator ST may be connected to the control electrode of the seventh switching element S7 of the gate signal masking circuit MC and the control electrode of the eighth switching element S8 of the gate signal masking circuit MC.

In an embodiment, for example, the control electrode of the ninth gate switching element T9 of the carry generator ST may be connected to the first electrode of the first switching element S1 of the gate signal masking circuit MC.

In an embodiment, the previous carry signal GC_CR(n−1) may be a carry signal of an immediately previous stage of a present stage. However, the invention may not be limited thereto. Alternatively, the previous carry signal GC_CR(n−1) may be a carry signal of one of previous stages of the present stage.

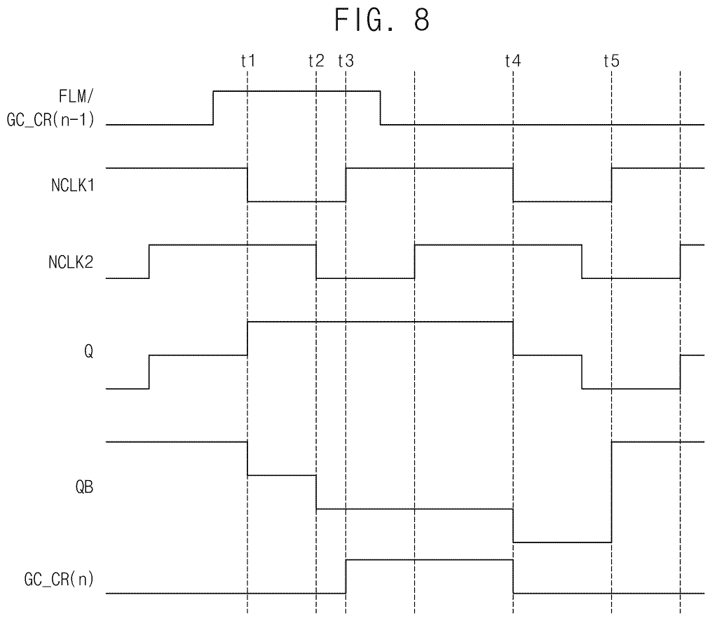

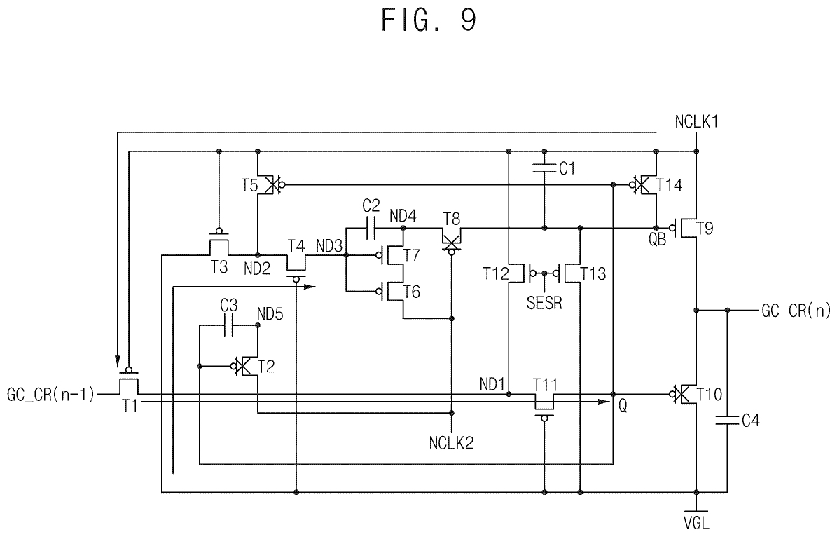

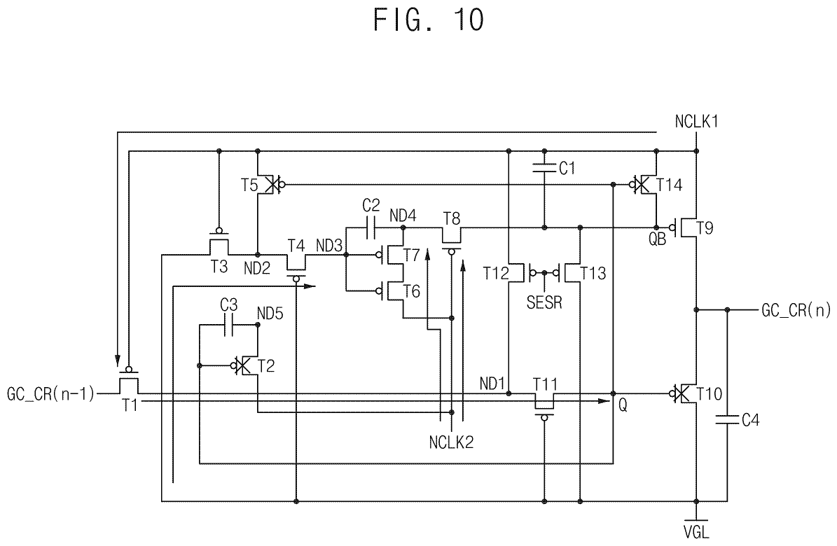

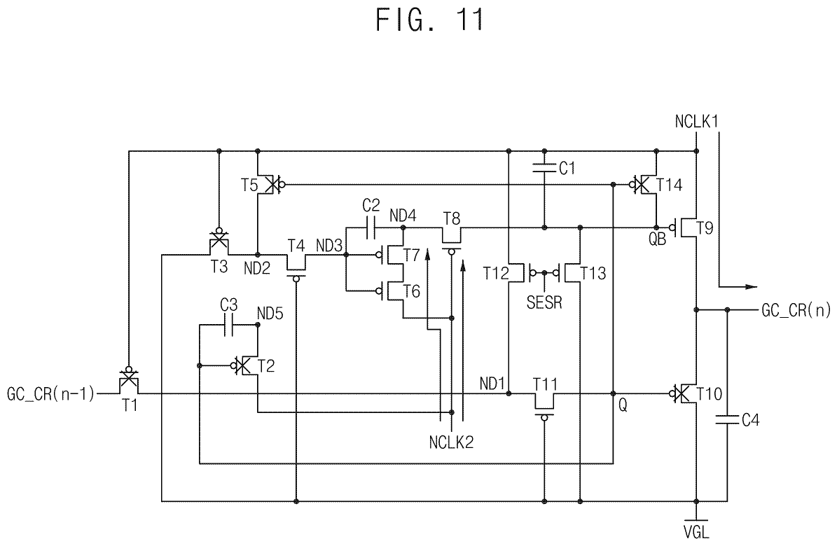

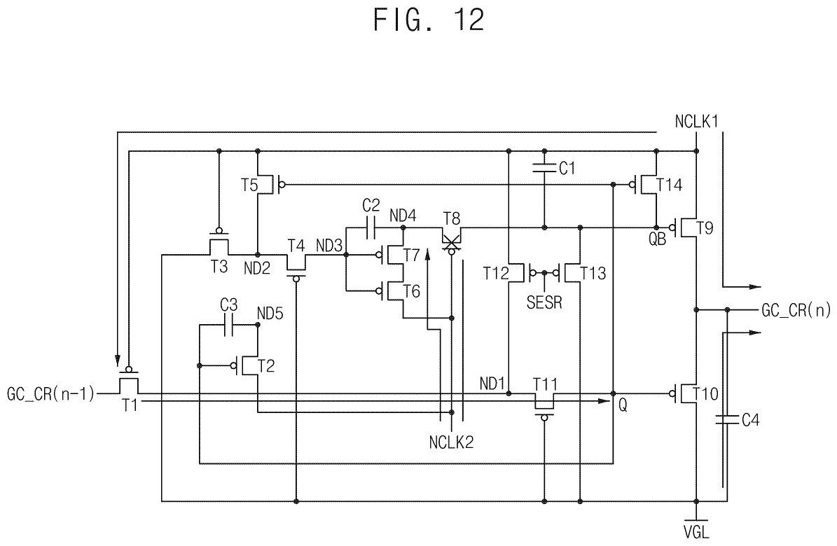

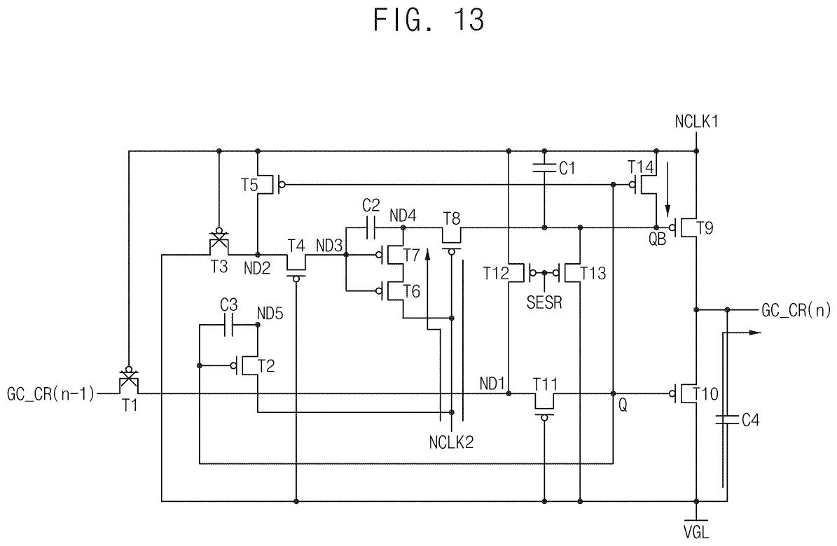

FIG. 8 is a signal timing diagram illustrating input signals, node signals and an output signal of the carry generator ST of FIG. 7. FIG. 9 is a circuit diagram illustrating an operation of the carry generator ST of FIG. 7 in a first time point t1 of FIG. 8. FIG. 10 is a circuit diagram illustrating an operation of the carry generator ST of FIG. 7 in a second time point t2 of FIG. 8. FIG. 11 is a circuit diagram illustrating an operation of the carry generator ST of FIG. 7 in a third time point t3 of FIG. 8. FIG. 12 is a circuit diagram illustrating an operation of the carry generator ST of FIG. 7 in a fourth time point t4 of FIG. 8. FIG. 13 is a circuit diagram illustrating an operation of the carry generator ST of FIG. 7 in a fifth time point t5 of FIG. 8.

Hereinafter, the operation of the carry generator ST will be described in detail referring to FIGS. 8 to 13. A waveform of the signal of the second control node Q is briefly illustrated in FIG. 8. The waveform of the signal of the second control node Q is illustrated in FIGS. 17 to 20 and 22 in detail.

As shown in FIGS. 8 and 9, a vertical start signal FLM or the previous carry signal GC_CR(n−1) may have an active level (e.g., a high level) and the first clock signal NCLK1 may have a low level at the first time point t1.

At the first time point t1, the voltage of the second control node Q may have a high level. At the first time point t1, the first clock signal NCLK1 is coupled through the first capacitor C1 such that the voltage of the first control node QB may be changed to a first low level.

At the first time point t1, the third gate switching element T3 and the fourth gate switching element T4 are turned on and the second capacitor C2 may be charged.

As shown in FIGS. 8 and 10, the second clock signal NCLK2 falls from a high level to a low level at the second time point t2.

At the second time point t2, the voltage of the first control node QB may be changed to a second low level by a boosting of the second capacitor C2.

At the second time point t2, the ninth gate switching element T9 has a turned-on state and the first clock signal NCLK1 has a low level such that the low level is outputted as the carry signal GC_CR(n).

At the second time point t2, the low power voltage VGL is charged at the first capacitor C1.

As shown in FIGS. 8 and 11, the first clock signal NCLK1 rises from the low level to a high level at a third time point t3.

When the first clock signal NCLK1 rises from the low level to the high level in a turned-on state of the ninth gate switching element T9 at the third time point t3, the high level is outputted as the carry signal GC_CR(n).

As shown in FIGS. 8 and 12, the first clock signal NCLK1 falls from the high level to the low level at the fourth time point t4.

When the first clock signal NCLK1 falls to the low level at the fourth time point t4, the vertical start signal FLM or the previous carry signal GC_CR(n−1) has a low state in the fourth time point t4 such that the voltage of the second control node Q may become the low level. In addition, the voltage of the first control node QB may fall to a third low level at the fourth time point t4.

When the second control node Q is the low level in the fourth time point t4, the tenth gate switching element T10 is turned on such that the low level of the low power voltage VGL is outputted as the carry signal GC_CR(n) by the tenth gate switching element T10.

In addition, in the fourth time point t4, the fourteenth gate switching element T14 is turned on by the voltage of the second control node Q and the ninth gate switching element T9 is turned on by the first clock signal NCLK1 such that a falling edge of the first clock signal NCLK1 is outputted as the carry signal GC_CR(n).

As shown in FIGS. 8 and 13, the first clock signal NCLK1 rises from the low level to the high level at the fifth time point t5.

When the first clock signal NCLK1 rises from the low level to the high level at the fifth time point t5, the voltage of the second control node Q maintains the low level. The tenth gate switching element T10 is turned on by the low level of the voltage of the second control node Q in the fifth time point t5, and the low level of the low power voltage VGL is outputted as the carry signal GC_CR(n) by the tenth gate switching element T10.

In addition, the fourteenth gate switching element T14 is turned on by the low level of the voltage of the second control node Q in the fifth time point t5, and the voltage of the first control node QB becomes a high state at a rising edge of the first clock signal NCLK1 by the fourteenth gate switching element T14.

In an embodiment, where the second clock signal NCLK2 falls when the signal of the second control node Q has the low level at the fifth time point t5, the signal of the second control node Q may fall to a second low level at the fifth time point t5.

When the reset signal SESR is applied to the twelfth gate switching element T12 and the thirteenth gate switching element T13, the twelfth gate switching element T12 and the thirteenth gate switching element T13 are turned on such that the voltage of the second control node Q may be initialized by the twelfth gate switching element T12 and the voltage of the first control node QB may be initialized by the thirteenth gate switching element T13. When the reset signal SESR is applied, the gate driver 300 may output the gate signal GC(n) having the high level.

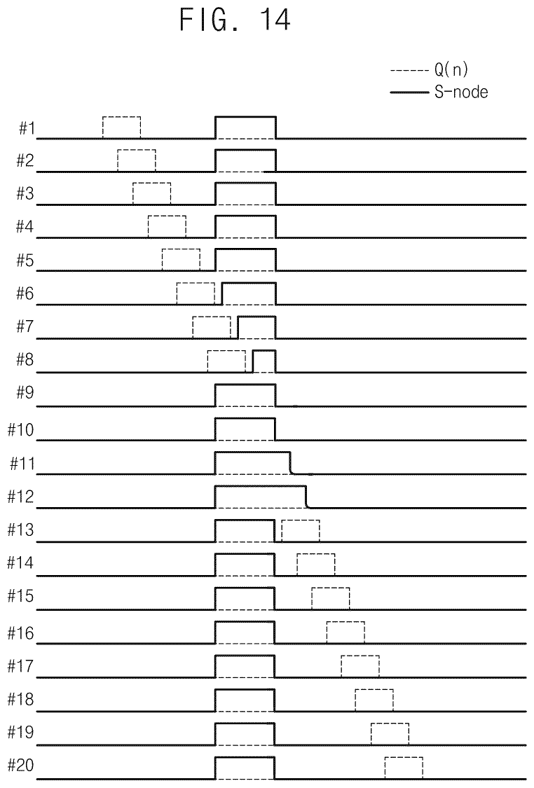

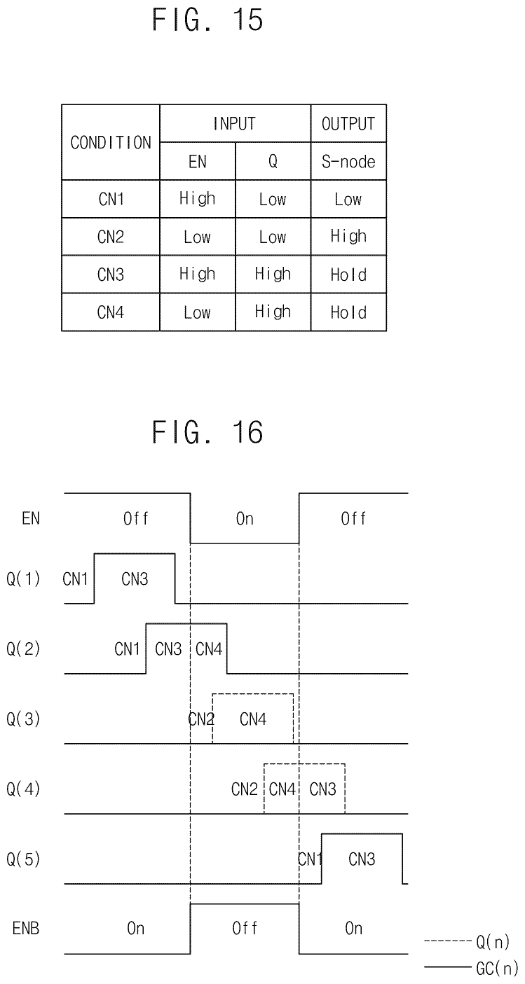

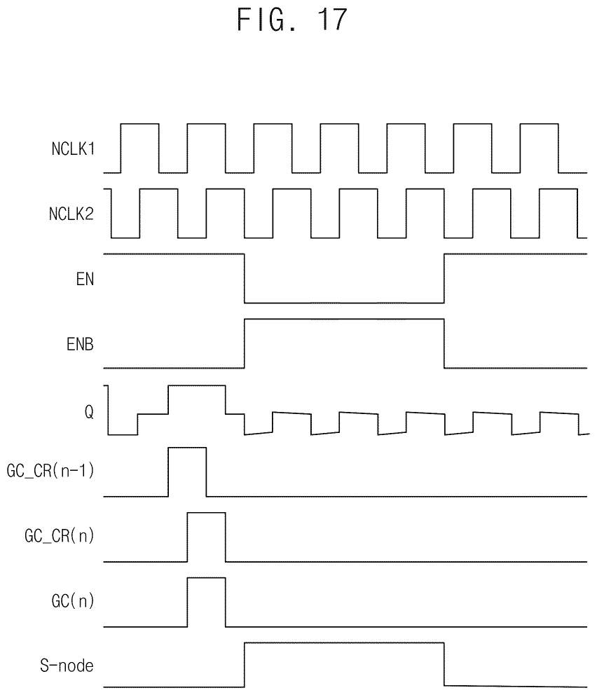

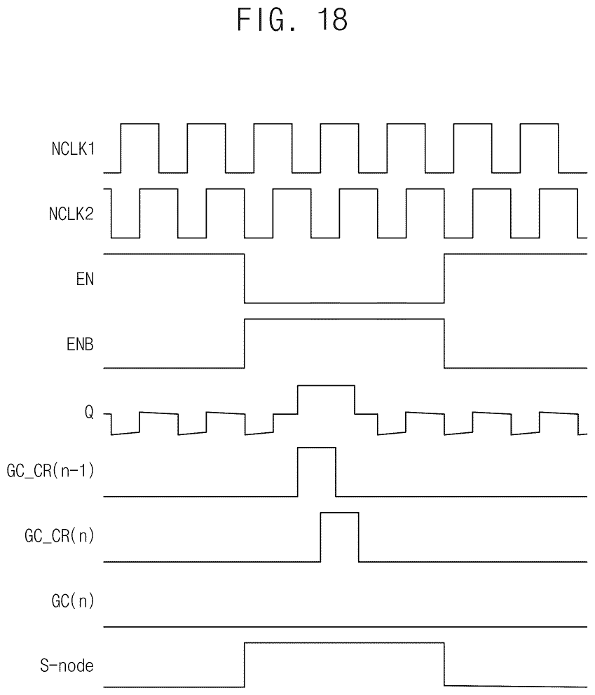

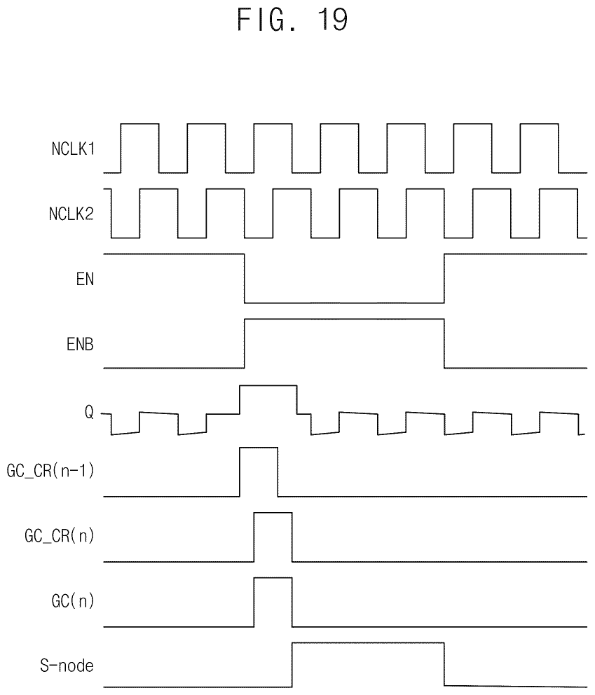

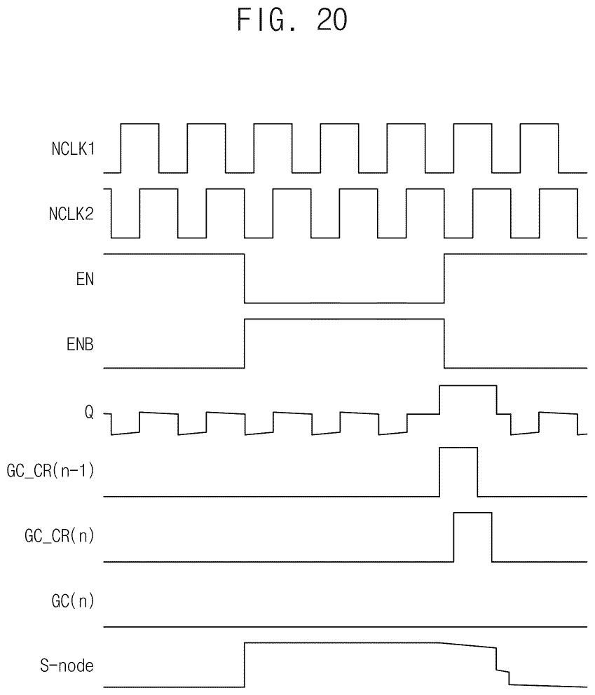

FIG. 14 is a signal timing diagram illustrating a signal of a masking control node S-node and a signal of the second control node Q(n) of the gate signal masking circuit MC of FIG. 7. FIG. 15 is a table illustrating a state of the signal of the masking control node S-node according to an input signal of the gate signal masking circuit MC of FIG. 7. FIG. 16 is a signal timing diagram illustrating an output signal of the gate signal masking circuit MC according to the input signal of the gate signal masking circuit MC of FIG. 7. FIG. 17 is a signal timing diagram illustrating input signals, a node signal and output signals of the carry generator ST and the gate signal masking circuit MC of FIG. 7 in a first case. FIG. 18 is a signal timing diagram illustrating input signals, a node signal and output signals of the carry generator ST and the gate signal masking circuit MC of FIG. 7 in a second case. FIG. 19 is a signal timing diagram illustrating input signals, a node signal and output signals of the carry generator ST and the gate signal masking circuit MC of FIG. 7 in a third case. FIG. 20 is a signal timing diagram illustrating input signals, a node signal and output signals of the carry generator ST and the gate signal masking circuit MC of FIG. 7 in a fourth case.

Hereinafter, the operation of the gate signal masking circuit MC will be described in detail referring to FIGS. 14 to 20. A waveform of the signal of the second control node Q(n) is briefly illustrated in FIGS. 14 and 16. The waveform of the signal of the second control node Q(n) is illustrated in FIGS. 17 to 20 and 22 in detail.

In an embodiment, as shown in FIG. 7, the gate signal masking circuit MC may include eight transistors S1 to S8 and two capacitors CM1 and CM2.

The gate driver 300 may use an output of the carry generator ST as the carry signal GC_CR(n) and an output of the gate signal masking circuit MC as the gate signal GC(n) for the multiple division of the driving frequency.

The first control node QB and the second control node Q of the carry generator ST may be connected to the gate signal masking circuit MC.

As the state of the masking control node S-node and the state of the first switching element S1 are changed based on the first enable signal EN, the second enable signal ENB and a frequency control signal, the gate signal masking circuit MC operates.

FIG. 14 illustrates a case in which the gate signal GC(n) is not outputted from ninth to twelfth gate lines (#9 to #12) among twenty gate lines (#1 to #20) due to a gate signal masking operation.

First to eighth gate lines (#1 to #8) and thirteenth to twentieth gate lines (#13 to #20) may output gate pulses. The ninth to twelfth gate lines (#9 to #12) may not output gate pulses.

As shown in FIG. 14, on the line where the gate pulse is not outputted, the masking control node S-node may maintain a high level. When the masking control node S-node maintains the high level, the first switching element S1 may be turned off and the sixth switching element S6 may be turned off such that the gate output node may not output the gate pulse.

The sixth switching element S6 operates similarly to the ninth gate switching element T9 of the carry generator ST. The ninth gate switching element T9 outputs the first clock signal NCLK1 as the carry signal GC_CR(n) in response to the first control node QB. The sixth gate switching element T6 outputs the first clock signal NCLK1 as the gate signal GC(n) in response to the third control node QM.

The seventh switching element S7 operates similarly to the tenth gate switching element T10 of the carry generator ST. The tenth gate switching element T10 outputs the low power voltage VGL as the low level of the carry signal GC_CR(n) in response to the voltage of the second control node Q. The seventh switching element S7 outputs the low power voltage VGL as the low level of the gate signal GC(n) in response to the voltage of the second control node Q.

The eighth switching element S8 operates similarly to the fourteenth gate switching element T14 of the carry generator ST. The fourteenth gate switching element T14 outputs the first clock signal NCLK1 to the first control node QB in response to the voltage of the second control node Q. The eighth gate switching element T8 outputs the first clock signal NCLK1 to the third control node QM in response to the voltage of the second control node Q.

The signal of the masking control node S-node may be determined by operations of the second to fifth switching elements S2 to S5.

In an embodiment, for example, when the signal of the second control node Q(n) has the low level and the first enable signal EN has the low level, the second switching element S2 and the third switching element S3 are turned on such that the high power voltage VGH may be applied to the masking control node S-node.

In an embodiment, as shown in FIG. 6, the second enable signal ENB may have an inverted waveform of a waveform of the first enable signal EN. Thus, when the third switching element S3 is turned on in response to the first enable signal EN, the fourth switching element S4 may be turned off in response to the second enable signal ENB.

In an embodiment, for example, when the signal of the second control node Q(n) has the low level and the second enable signal ENB has the low level, the fourth switching element S4 and the fifth switching element S5 are turned on such that the second low power voltage VGL2 may be applied to the masking control node S-node.

The second enable signal ENB may have the inverted waveform of the waveform of the first enable signal EN. Thus, when the fourth switching element S4 is turned on in response to the second enable signal ENB, the third switching element S3 may be turned off in response to the first enable signal EN.

When the signal of the second control node Q(n) has the high level, the second switching element S2 and the fifth switching element S5 are turned off such that the masking control node S-node may maintain a previous state regardless of the state of the first enable signal EN and the state of the second enable signal ENB.

In FIG. 15, a state of the signal of the masking control node S-node according to the input signal EN and Q(n) of the gate signal masking circuit MC in an embodiment is illustrated as a table.

Referring to FIG. 15, when the enable signal EN has a high level and the signal of the second control node Q(n) has a low level, the signal of the masking control node S-node may have a low level. This condition may be defined as a first condition CN1.

When the enable signal EN has a low level and the signal of the second control node Q(n) has a low level, the signal of the masking control node S-node may have a high level. This condition may be defined as a second condition CN2.

When the enable signal EN has a high level and the signal of the second control node Q(n) has a high level, a previous state of the signal of the masking control node S-node may be maintained (Hold). This condition may be defined as a third condition CN3.

When the enable signal EN has a low level and the signal of the second control node Q(n) has a high level, a previous state of the signal of the masking control node S-node may be maintained (Hold). This condition may be defined as a fourth condition CN4.

In an embodiment, as shown in FIG. 16, for example, a signal of a second control node Q(1) of a first line may sequentially have the first condition CN1 and the third condition CN3 and a gate signal GC(1) of the first line may be normally outputted.

In an embodiment, as shown in FIG. 16, for example, a signal of a second control node Q(2) of a second line of FIG. 16 may sequentially have the first condition CN1, the third condition CN3 and the fourth condition CN4 and a gate signal GC(2) of the second line may be normally outputted.

In such an embodiment, a signal of a second control node Q(3) of a third line may sequentially have the second condition CN2 and the fourth condition CN4 and a gate signal GC(3) of the third line may be masked and accordingly, not outputted.

In such an embodiment, a signal of a second control node Q(4) of a fourth line may sequentially have the second condition CN2, the fourth condition CN4 and the third condition CN3 and a gate signal GC(4) of the fourth line may be masked and accordingly, not outputted.

In such an embodiment, a signal of a second control node Q(5) of a fifth line may sequentially have the first condition CN1 and the third condition CN3 and a gate signal GC(5) of the fifth line may be normally outputted.

FIG. 17 illustrates a case where the first enable signal EN has an inactive level (e.g., a high level) in all periods in which the signal of the second control node Q has an active level (e.g., a high level).

When the first enable signal EN has the inactive level in all periods in which the signal of the second control node Q has the active level, the gate signal masking circuit MC may output the gate pulse.

FIG. 18 illustrates a case where the first enable signal EN has an active level (e.g., a low level) in all periods in which the signal of the second control node Q has the active level (e.g., a high level).

When the first enable signal EN has the active level in all periods in which the signal of the second control node Q has the active level, the gate signal masking circuit MC may not output the gate pulse.

FIG. 19 illustrates a case where the first enable signal EN is changed from the inactive level (e.g., a high level) to the active level (e.g., a low level) during a period in which the signal of the second control node Q has the active level (e.g., a high level).

When the first enable signal EN is changed from the inactive level to the active level during a period in which the signal of the second control node Q has the active level, the gate signal masking circuit MC may output the gate pulse.

FIG. 20 illustrates a case where the first enable signal EN is changed from the active level (e.g., a low level) to the inactive level (e.g., a high level) during a period in which the signal of the second control node Q has the active level (e.g., a high level).

When the first enable signal EN is changed from the active level to the inactive level during a period in which the signal of the second control node Q has the active level, the gate signal masking circuit MC may not output the gate pulse.

As described above referring to FIGS. 17 to 20, in an embodiment, when the first enable signal EN has the inactive level (e.g., the high level) at the rising edge of the signal of the second control node Q, the gate signal masking circuit MC may output the gate pulse. In such an embodiment, when the first enable signal EN has the active level (e.g., the low level) at the rising edge of the signal of the second control node Q, the gate signal masking circuit MC may not output the gate pulse.

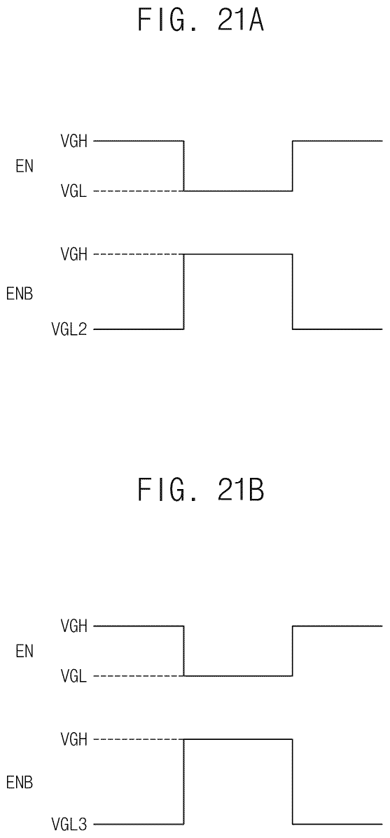

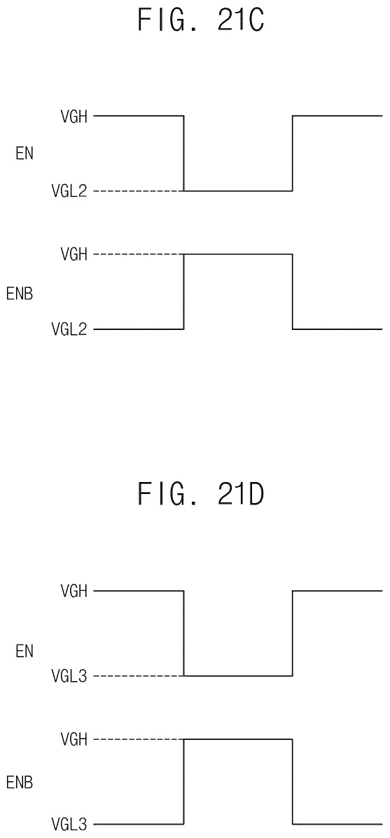

FIG. 21A is a signal timing diagram illustrating examples of a waveform of a first enable signal EN and a waveform of a second enable signal ENB applied to the gate signal masking circuit MC of FIG. 7.

Referring to FIG. 21A, the first enable signal EN may have an inverted waveform of a waveform of the second enable signal ENB.

In an embodiment, for example, a high level of the first enable signal EN may be the same as a high level of the second enable signal ENB but a low level of the first enable signal EN may be different from a low level of the second enable signal ENB.

The high level of the first enable signal EN may be the high power voltage VGH. The low level of the first enable signal EN may be the low power voltage VGL.

The high level of the second enable signal ENB may be the high power voltage VGH. The low level of the second enable signal ENB may be the second low power voltage VGL2.

In an embodiment, the second low power voltage VGL2 is applied to the second electrode of the fifth switching element S5 such that the low level of the second enable signal ENB applied to the fourth switching element S4 may be the second low power voltage VGL2. Thus, a voltage drop may be enhanced at the fourth switching element S4.

FIG. 21B is a signal timing diagram illustrating examples of a waveform of a first enable signal EN and a waveform of a second enable signal ENB applied to the gate signal masking circuit MC of FIG. 7.

Referring to FIG. 21B, the first enable signal EN may have an inverted waveform of a waveform of the second enable signal ENB.

In an embodiment, for example, a high level of the first enable signal EN may be the same as a high level of the second enable signal ENB but a low level of the first enable signal EN may be different from a low level of the second enable signal ENB.

The high level of the first enable signal EN may be the high power voltage VGH. The low level of the first enable signal EN may be the low power voltage VGL.

The high level of the second enable signal ENB may be the high power voltage VGH. The low level of the second enable signal ENB may be a third low power voltage VGL3 different from the second low power voltage VGL2. In an embodiment, for example, the third low power voltage VGL3 may be less than the second low power voltage VGL2.

In an embodiment, the second low power voltage VGL2 is applied to the second electrode of the fifth switching element S5 such that the low level of the second enable signal ENB applied to the fourth switching element S4 may be the third low power voltage VGL3. Thus, a voltage drop may be enhanced at the fourth switching element S4.

FIG. 21C is a signal timing diagram illustrating examples of a waveform of a first enable signal EN and a waveform of a second enable signal ENB applied to the gate signal masking circuit MC of FIG. 7.

Referring to FIG. 21C, the first enable signal EN may have an inverted waveform of a waveform of the second enable signal ENB.

In an embodiment, for example, a high level of the first enable signal EN may be the same as a high level of the second enable signal ENB and a low level of the first enable signal EN may be the same as a low level of the second enable signal ENB.

The high level of the first enable signal EN may be the high power voltage VGH. The low level of the first enable signal EN may be the second low power voltage VGL2.

The high level of the second enable signal ENB may be the high power voltage VGH. The low level of the second enable signal ENB may be the second low power voltage VGL2.

In an embodiment, the second low power voltage VGL2 is applied to the second electrode of the fifth switching element S5 such that the low level of the second enable signal ENB applied to the fourth switching element S4 may be the second low power voltage VGL2. Thus, a voltage drop may be enhanced at the fourth switching element S4.

FIG. 21D is a signal timing diagram illustrating examples of a waveform of a first enable signal EN and a waveform of a second enable signal ENB applied to the gate signal masking circuit MC of FIG. 7.

Referring to FIG. 21D, the first enable signal EN may have an inverted waveform of a waveform of the second enable signal ENB.

In an embodiment, for example, a high level of the first enable signal EN may be the same as a high level of the second enable signal ENB and a low level of the first enable signal EN may be the same as a low level of the second enable signal ENB.

The high level of the first enable signal EN may be the high power voltage VGH. The low level of the first enable signal EN may be the third low power voltage VGL3 different from the low power voltage VGL and the second low power voltage VGL2. In an embodiment, for example, the third low power voltage VGL3 may be less than the second low power voltage VGL2.

The high level of the second enable signal ENB may be the high power voltage VGH. The low level of the second enable signal ENB may be the third low power voltage VGL3.

In an embodiment, the second low power voltage VGL2 is applied to the second electrode of the fifth switching element S5 such that the low level of the second enable signal ENB applied to the fourth switching element S4 may be the third low power voltage VGL3. Thus, a voltage drop may be enhanced at the fourth switching element S4.

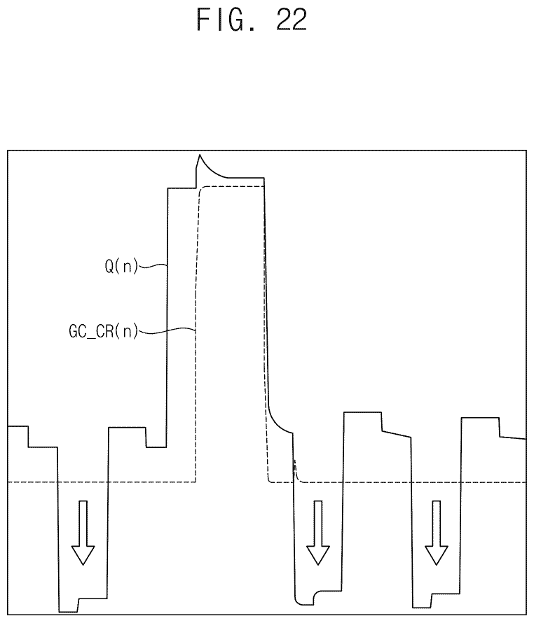

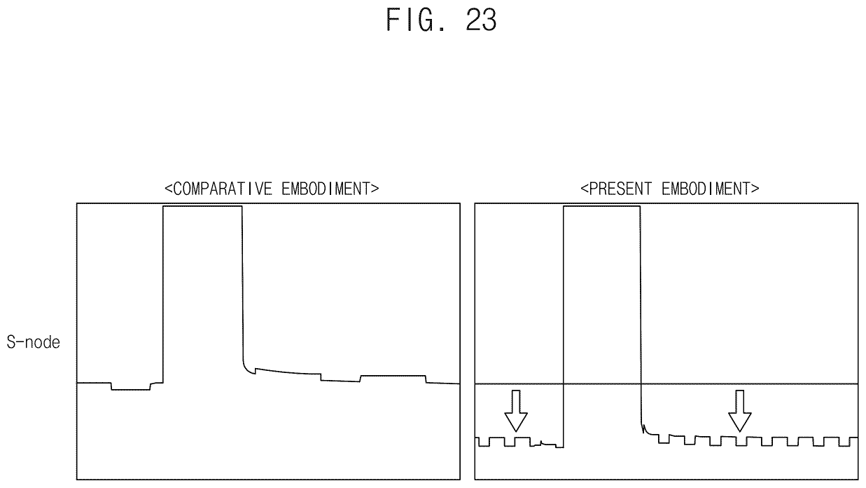

FIG. 22 is a signal timing diagram illustrating a carry signal GC_CR(n) and a signal of the second control node Q(n) of the carry generator ST of FIG. 7. FIG. 23 is a signal timing diagram illustrating a signal of a masking control node S-node of a gate signal masking circuit MC according to a comparative embodiment and an embodiment of the invention (hereinafter, will be referred to as “present embodiment”).

Referring to FIG. 22, the low level of the carry signal GC_CR(n) may be the low power voltage VGL, while the low level of the signal of the second control node Q(n) may decrease to a level less than the low power voltage VGL in response to a falling of the second clock signal NCLK2.

In the comparative embodiment of FIG. 23, the signal of the masking control node S-node may be determined by applying the carry signal GC_CR(n) to the control electrode of the second switching element S2 and the control electrode of the fifth switching element S5. In the comparative embodiment of FIG. 23, the signal of the masking control node S-node is determined based on the carry signal GC_CR(n) such that the low level of the masking control node S-node may be relatively high.

In the embodiment of FIG. 23, the signal of the masking control node S-node may be determined by applying the signal of the second control node Q(n) to the control electrode of the second switching element S2 and the control electrode of the fifth switching element S5. In the embodiment of FIG. 23, the signal of the masking control node S-node is determined based on the signal of the second control node Q(n) such that the low level of the masking control node S-node may be decreased and accordingly, the reliability of the gate signal masking circuit MC may be enhanced.

According to an embodiment, the output of the gate signal GC(n) may be controlled based on the signal of the second control node Q applied to the pull-down switching element T10 that pulls down the carry signal GC_CR(n), the first enable signal EN and the second enable signal ENB such that the multiple division of the driving frequency may be effectively performed.

Through the multiple division of the driving frequency, the power consumption of the display apparatus may be effectively reduced.

The signal of the masking control node S-node may be determined based on the signal of the second control node Q such that the reliability of the gate signal masking circuit MC may be enhanced by decreasing the low level of the signal of the masking control node S-node.

In addition, the second low power voltage VGL2 less than the low power voltage VGL is applied to the second electrode of the fifth switching element S5 such that the reliability of the gate signal masking circuit MC may be enhanced by decreasing the low level of the signal of the masking control node S-node.

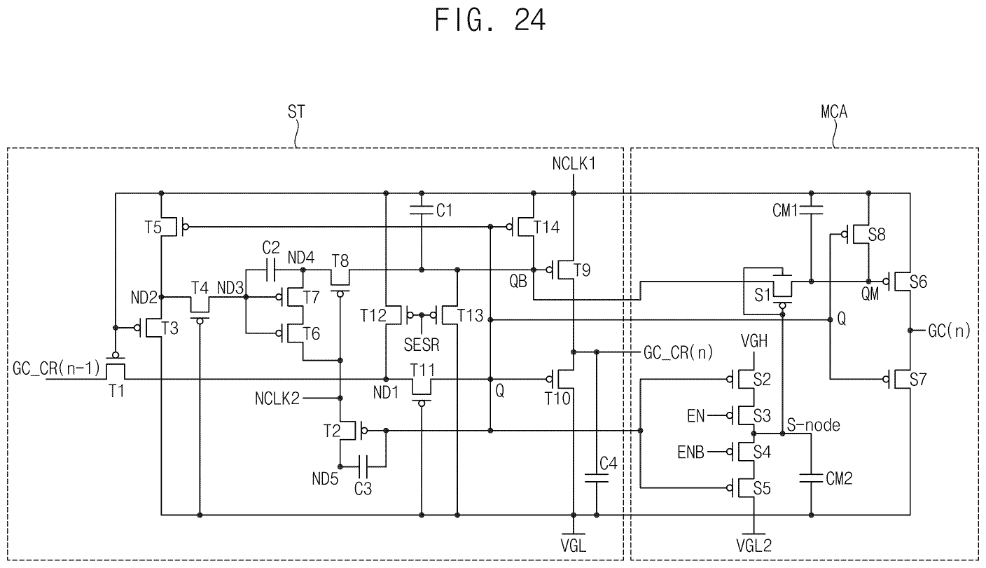

FIG. 24 is a circuit diagram illustrating a carry generator ST and a gate signal masking circuit MCA of the gate driver 300 according to an embodiment of the invention.

The gate signal masking circuit, the gate driver and the display apparatus according to the embodiment of FIG. 24 is substantially the same as the gate signal masking circuit, the gate driver and the display apparatus of the embodiments described above referring to FIGS. 1 to 23 except for the first switching element of the gate signal masking circuit. Thus, the same reference numerals will be used to refer to the same or like parts as those described with reference to FIGS. 1 to 23 and any repetitive detailed description thereof will be omitted or simplified.

Referring to FIGS. 1 to 6 and 8 to 24, an embodiment of the display apparatus includes a display panel 100 and a display panel driver. The display panel driver includes a driving controller 200, a gate driver 300, a gamma reference voltage generator 400, a data driver 500 and an emission driver 600.

The gate driver 300 may include the carry generator ST that generates a carry signal GC_CR(n) based on a previous carry signal GC_CR(n−1), a first clock signal NCLK1, a second clock signal NCLK2 and a low power voltage VGL and a gate signal masking circuit MCA connected to the carry generator ST.

The gate signal masking circuit MCA may include first to fifth switching elements S1 to S5. The first switching element S1 may include a control electrode connected to a masking control node S-node, a first electrode connected to a first control node QB and a second electrode connected to a third control node QM. The second switching element S2 may include a control electrode connected to a second control node Q, a first electrode that receives a masking power signal and a second electrode connected to a first intermediate node. The third switching element S3 may include a control electrode that receives the first enable signal EN, a first electrode connected to the first intermediate node and a second electrode connected to the masking control node S-node. The fourth switching element S4 may include a control electrode that receives the second enable signal ENB, a first electrode connected to the masking control node S-node and a second electrode connected to a second intermediate node. The fifth switching element S5 may include a control electrode connected to the second control node Q, a first electrode connected to the second intermediate node and a second electrode that receives a second low power voltage VGL2.

In an embodiment, the first switching element S1 may further include an additional control electrode (hereinafter, will be referred to as “second control electrode”) connected to the masking control node S-node. The first switching element S1 may be a dual gate switching element including two control electrodes. Accordingly, a voltage drop at the first switching element S1 may be enhanced such that the low level of the signal of the third control node QM may be further decreased and the reliability of the gate signal masking circuit MCA may be enhanced.

According to an embodiment, the output of the gate signal GC(n) may be controlled based on the signal of the second control node Q applied to the pull-down switching element T10 that pulls down the carry signal GC_CR(n), the first enable signal EN and the second enable signal ENB such that the multiple division of the driving frequency may be effectively performed.

Through the multiple division of the driving frequency, the power consumption of the display apparatus may be effectively reduced.

The signal of the masking control node S-node may be determined based on the signal of the second control node Q such that the reliability of the gate signal masking circuit MCA may be enhanced by decreasing the low level of the signal of the masking control node S-node.

In addition, the second low power voltage VGL2 less than the low power voltage VGL is applied to the second electrode of the fifth switching element S5 such that the reliability of the gate signal masking circuit MCA may be enhanced by decreasing the low level of the signal of the masking control node S-node.

In addition, the first switching element S1 may further include the second control electrode connected to the masking control node S-node such that the reliability of the gate signal masking circuit MCA may be enhanced by decreasing the low level of the signal of the third control node QM.

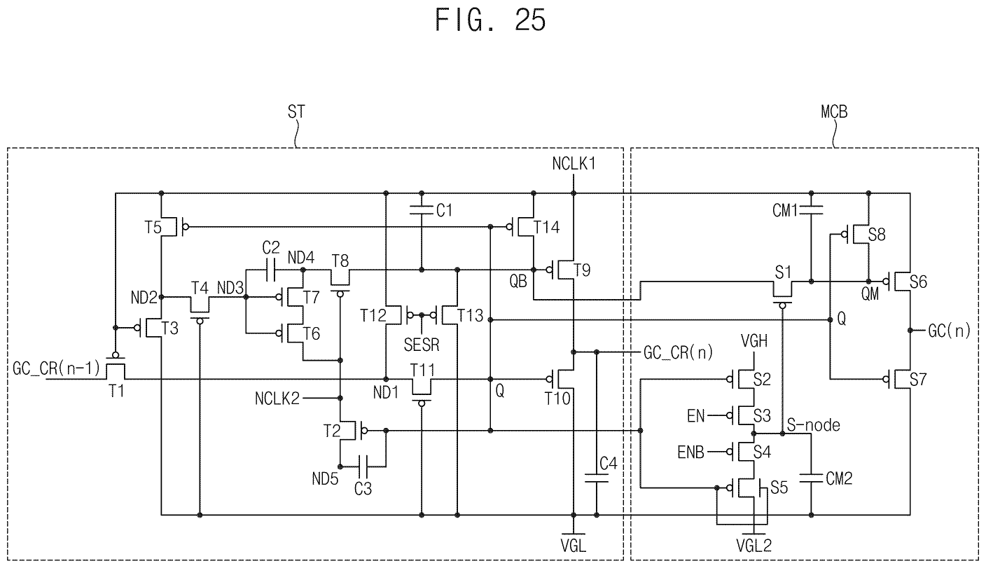

FIG. 25 is a circuit diagram illustrating a carry generator ST and a gate signal masking circuit MCB of the gate driver 300 according to an embodiment of the invention.

The gate signal masking circuit, the gate driver and the display apparatus according to the embodiment of FIG. 25 is substantially the same as the gate signal masking circuit, the gate driver and the display apparatus of the embodiments described above referring to FIGS. 1 to 23 except for the fifth switching element of the gate signal masking circuit. Thus, the same reference numerals will be used to refer to the same or like parts as those described above with reference to FIGS. 1 to 23 and any repetitive detailed description thereof will be omitted or simplified.

Referring to FIGS. 1 to 6 and 8 to 23 and 25, an embodiment of the display apparatus includes a display panel 100 and a display panel driver. The display panel driver includes a driving controller 200, a gate driver 300, a gamma reference voltage generator 400, a data driver 500 and an emission driver 600.

The gate driver 300 may include the carry generator ST that generates a carry signal GC_CR(n) based on a previous carry signal GC_CR(n−1), a first clock signal NCLK1, a second clock signal NCLK2 and a low power voltage VGL and a gate signal masking circuit MCB connected to the carry generator ST.

The gate signal masking circuit MCB may include first to fifth switching elements S1 to S5. The first switching element S1 may include a control electrode connected to a masking control node S-node, a first electrode connected to a first control node QB and a second electrode connected to a third control node QM. The second switching element S2 may include a control electrode connected to a second control node Q, a first electrode that receives a masking power signal and a second electrode connected to a first intermediate node. The third switching element S3 may include a control electrode that receives the first enable signal EN, a first electrode connected to the first intermediate node and a second electrode connected to the masking control node S-node. The fourth switching element S4 may include a control electrode that receives the second enable signal ENB, a first electrode connected to the masking control node S-node and a second electrode connected to a second intermediate node. The fifth switching element S5 may include a control electrode connected to the second control node Q, a first electrode connected to the second intermediate node and a second electrode that receives a second low power voltage VGL2.

In an embodiment, the fifth switching element S5 may further include an additional control electrode (hereinafter, will be referred to as “second control electrode”) connected to the second control node Q. The fifth switching element S5 may be a dual gate switching element including two control electrodes. Accordingly, a voltage drop at the fifth switching element S5 may be enhanced such that the low level of the signal of the masking control node S-node may be further decreased and the reliability of the gate signal masking circuit MCB may be enhanced.

According to an embodiment, the output of the gate signal GC(n) may be controlled based on the signal of the second control node Q applied to the pull-down switching element T10 that pulls down the carry signal GC_CR(n), the first enable signal EN and the second enable signal ENB such that the multiple division of the driving frequency may be effectively performed.

Through the multiple division of the driving frequency, the power consumption of the display apparatus may be effectively reduced.

The signal of the masking control node S-node may be determined based on the signal of the second control node Q such that the reliability of the gate signal masking circuit MCB may be enhanced by decreasing the low level of the signal of the masking control node S-node.

In addition, the second low power voltage VGL2 less than the low power voltage VGL is applied to the second electrode of the fifth switching element S5 such that the reliability of the gate signal masking circuit MCB may be enhanced by decreasing the low level of the signal of the masking control node S-node.

In addition, the fifth switching element S5 may further include the second control electrode connected to the second control node Q such that the reliability of the gate signal masking circuit MCB may be enhanced by decreasing the low level of the signal of the masking control node S-node.

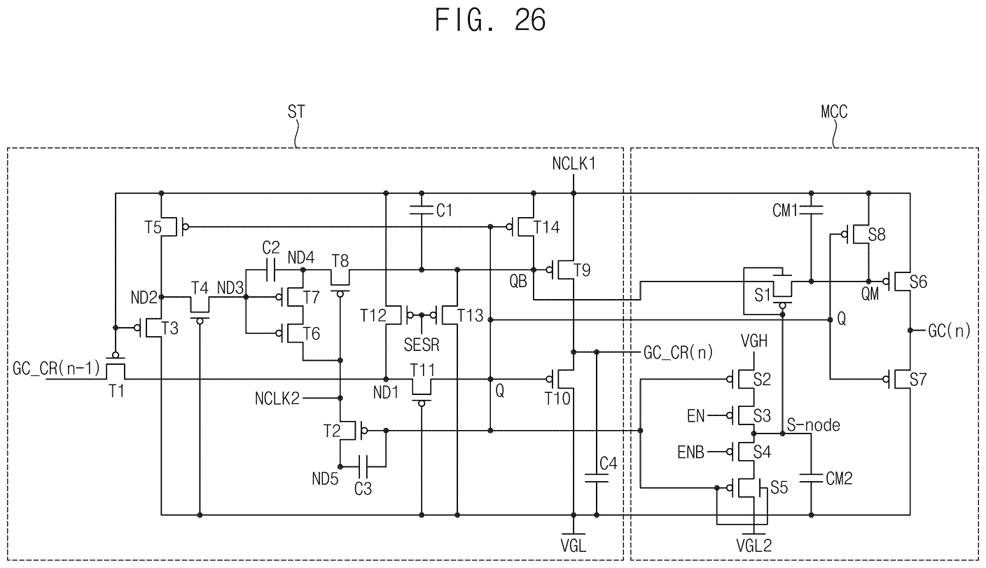

FIG. 26 is a circuit diagram illustrating a carry generator ST and a gate signal masking circuit MCC of the gate driver 300 according to an embodiment of the invention.

The gate signal masking circuit, the gate driver and the display apparatus according to the embodiment of FIG. 26 is substantially the same as the gate signal masking circuit, the gate driver and the display apparatus of the embodiments described above referring to FIGS. 1 to 23 except for the first switching element and the fifth switching element of the gate signal masking circuit. Thus, the same reference numerals will be used to refer to the same or like parts as those described above with reference to FIGS. 1 to 23 and any repetitive detailed description thereof will be omitted or simplified.

Referring to FIGS. 1 to 6 and 8 to 23 and 26, an embodiment of the display apparatus includes a display panel 100 and a display panel driver. The display panel driver includes a driving controller 200, a gate driver 300, a gamma reference voltage generator 400, a data driver 500 and an emission driver 600.

The gate driver 300 may include the carry generator ST that generates a carry signal GC_CR(n) based on a previous carry signal GC_CR(n−1), a first clock signal NCLK1, a second clock signal NCLK2 and a low power voltage VGL and a gate signal masking circuit MCC connected to the carry generator ST.

The gate signal masking circuit MCC may include first to fifth switching elements S1 to S5. The first switching element S1 may include a control electrode connected to a masking control node S-node, a first electrode connected to a first control node QB and a second electrode connected to a third control node QM. The second switching element S2 may include a control electrode connected to a second control node Q, a first electrode that receives a masking power signal and a second electrode connected to a first intermediate node. The third switching element S3 may include a control electrode that receives the first enable signal EN, a first electrode connected to the first intermediate node and a second electrode connected to the masking control node S-node. The fourth switching element S4 may include a control electrode that receives the second enable signal ENB, a first electrode connected to the masking control node S-node and a second electrode connected to a second intermediate node. The fifth switching element S5 may include a control electrode connected to the second control node Q, a first electrode connected to the second intermediate node and a second electrode that receives a second low power voltage VGL2.

In an embodiment, the first switching element S1 may further include a second control electrode connected to the masking control node S-node. The first switching element S1 may be a dual gate switching element including two control electrodes. Accordingly, a voltage drop at the first switching element S1 may be enhanced such that the low level of the signal of the third control node QM may be further decreased and the reliability of the gate signal masking circuit MCC may be enhanced.

In an embodiment, the fifth switching element S5 may further include a second control electrode connected to the second control node Q. The fifth switching element S5 may be a dual gate switching element including two control electrodes. Accordingly, a voltage drop at the fifth switching element S5 may be enhanced such that the low level of the signal of the masking control node S-node may be further decreased and the reliability of the gate signal masking circuit MCC may be enhanced.

According to an embodiment, the output of the gate signal GC(n) may be controlled based on the signal of the second control node Q applied to the pull-down switching element T10 that pulls down the carry signal GC_CR(n), the first enable signal EN and the second enable signal ENB such that the multiple division of the driving frequency may be effectively performed.

Through the multiple division of the driving frequency, the power consumption of the display apparatus may be effectively reduced.

The signal of the masking control node S-node may be determined based on the signal of the second control node Q such that the reliability of the gate signal masking circuit MCC may be enhanced by decreasing the low level of the signal of the masking control node S-node.

In addition, the second low power voltage VGL2 less than the low power voltage VGL is applied to the second electrode of the fifth switching element S5 such that the reliability of the gate signal masking circuit MCC may be enhanced by decreasing the low level of the signal of the masking control node S-node.

In addition, the first switching element S1 may further include the second control electrode connected to the masking control node S-node such that the reliability of the gate signal masking circuit MCC may be enhanced by decreasing the low level of the signal of the third control node QM.

In addition, the fifth switching element S5 may further include the second control electrode connected to the second control node Q such that the reliability of the gate signal masking circuit MCC may be enhanced by decreasing the low level of the signal of the masking control node S-node.

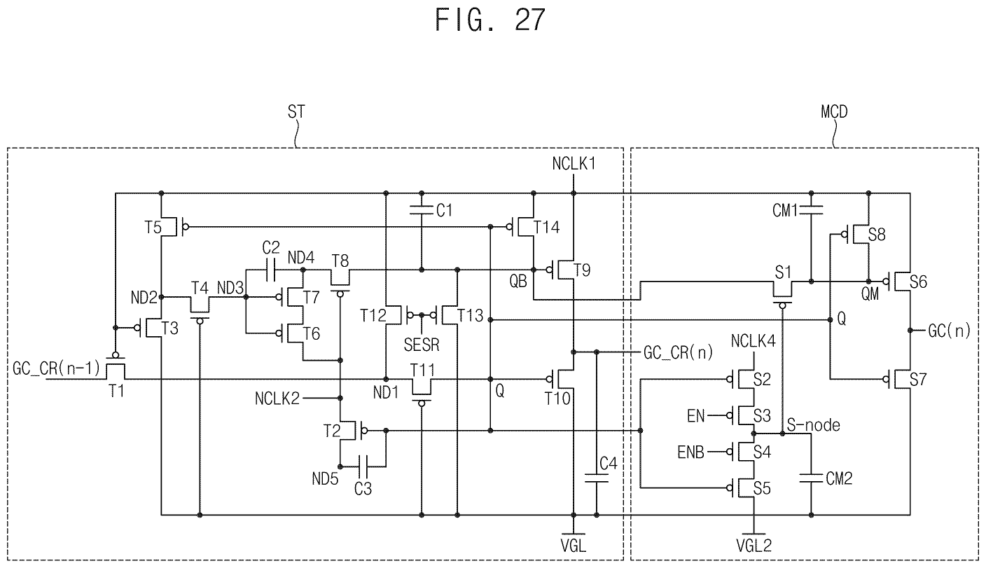

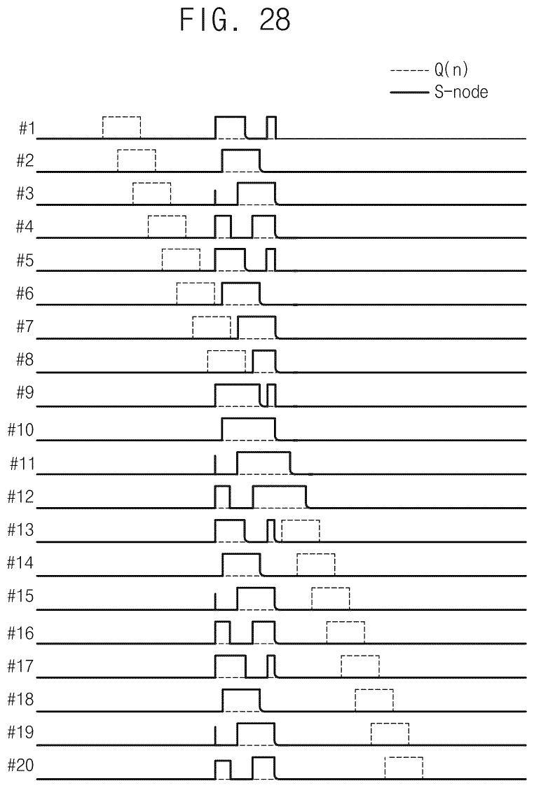

FIG. 27 is a circuit diagram illustrating a carry generator ST and a gate signal masking circuit MCD of a gate driver 300 according to an embodiment of the invention. FIG. 28 is a signal timing diagram illustrating a signal of a masking control node S-node and a signal of a second control node Q(n) of the gate signal masking circuit MCD of FIG. 27.

The gate signal masking circuit, the gate driver and the display apparatus according to the embodiment of FIG. 27 is substantially the same as the gate signal masking circuit, the gate driver and the display apparatus of the embodiments described above referring to FIGS. 1 to 23 except for the masking power signal of the gate signal masking circuit. Thus, the same reference numerals will be used to refer to the same or like parts as those described above with reference to FIGS. 1 to 23 and any repetitive detailed description thereof will be omitted or simplified.

Referring to FIGS. 1 to 6, 8 to 13, 15 to 23, 27 and 28, an embodiment of the display apparatus includes a display panel 100 and a display panel driver. The display panel driver includes a driving controller 200, a gate driver 300, a gamma reference voltage generator 400, a data driver 500 and an emission driver 600.

The gate driver 300 may include the carry generator ST that generates a carry signal GC_CR(n) based on a previous carry signal GC_CR(n−1), a first clock signal NCLK1, a second clock signal NCLK2 and a low power voltage VGL and a gate signal masking circuit MCD connected to the carry generator ST.

The gate signal masking circuit MCD may include first to fifth switching elements S1 to S5. The first switching element S1 may include a control electrode connected to a masking control node S-node, a first electrode connected to a first control node QB and a second electrode connected to a third control node QM. The second switching element S2 may include a control electrode connected to a second control node Q, a first electrode that receives a masking power signal and a second electrode connected to a first intermediate node. The third switching element S3 may include a control electrode that receives the first enable signal EN, a first electrode connected to the first intermediate node and a second electrode connected to the masking control node S-node. The fourth switching element S4 may include a control electrode that receives the second enable signal ENB, a first electrode connected to the masking control node S-node and a second electrode connected to a second intermediate node. The fifth switching element S5 may include a control electrode connected to the second control node Q, a first electrode connected to the second intermediate node and a second electrode that receives a second low power voltage VGL2.

In an embodiment, the masking power signal may be a clock signal NCLK4. The clock signal NCLK4 may have a high level when the first enable signal EN changes from an active level (e.g., a low level) to an inactive level (e.g., a high level) and when the first enable signal EN changes from the inactive level (e.g., a high level) to the active level (e.g., a low level).

A signal having a high level in a transition of the first enable signal EN and the second enable signal ENB may be used as the masking power signal.

When one (e.g. NCLK4) of the clock signals is used as the masking power signal as shown in FIG. 27, the carry generator ST and the gate signal masking circuit MCD may operate without an additional high power voltage (VGH of FIG. 7).

Hereinafter, the operation of the gate signal masking circuit MCD of FIG. 27 will be described in detail referring to FIG. 28.

FIG. 28 is a signal timing diagram illustrating a signal of a masking control node and a signal of a second control node of the gate signal masking circuit of FIG. 27. A waveform of the signal of the second control node Q(n) is briefly illustrated in FIG. 28. The waveform of the signal of the second control node Q(n) is illustrated in FIGS. 17 to 20 and 22 in detail.

In an embodiment, as described above, the gate signal masking circuit MCD may include eight transistors S1 to S8 and two capacitors CM1 and CM2.

The gate driver 300 may use an output of the carry generator ST as the carry signal GC_CR(n) and an output of the gate signal masking circuit MCD as the gate signal GC(n) for the multiple division of the driving frequency.

FIG. 28 illustrates a case in which the gate signal GC(n) is not outputted from ninth to twelfth gate lines (#9 to #12) among twenty gate lines (#1 to #20) due to a gate signal masking operation.

First to eighth gate lines (#1 to #8) and thirteenth to twentieth gate lines (#13 to #20) may output gate pulses. The ninth to twelfth gate lines (#9 to #12) may not output gate pulses.

As shown in FIG. 28, on the line where the gate pulse is not outputted, the masking control node S-node may maintain a high level. When the masking control node S-node maintains the high level, the first switching element S1 may be turned off and the sixth switching element S6 may be turned off such that the gate output node may not output the gate pulse. However, the masking power signal is the fourth clock signal NCLK4 in the embodiment such that the voltage of the masking control node S-node does not maintain a high level constantly may have a period having a low level according to the pulse of the fourth clock signal NCLK4.

According to an embodiment, the output of the gate signal GC(n) may be controlled based on the signal of the second control node Q applied to the pull-down switching element T10 that pulls down the carry signal GC_CR(n), the first enable signal EN and the second enable signal ENB such that the multiple division of the driving frequency may be effectively performed.

Through the multiple division of the driving frequency, the power consumption of the display apparatus may be effectively reduced.

The signal of the masking control node S-node may be determined based on the signal of the second control node Q such that the reliability of the gate signal masking circuit MCD may be enhanced by decreasing the low level of the signal of the masking control node S-node.

In addition, the second low power voltage VGL2 less than the low power voltage VGL is applied to the second electrode of the fifth switching element S5 such that the reliability of the gate signal masking circuit MCD may be enhanced by decreasing the low level of the signal of the masking control node S-node.

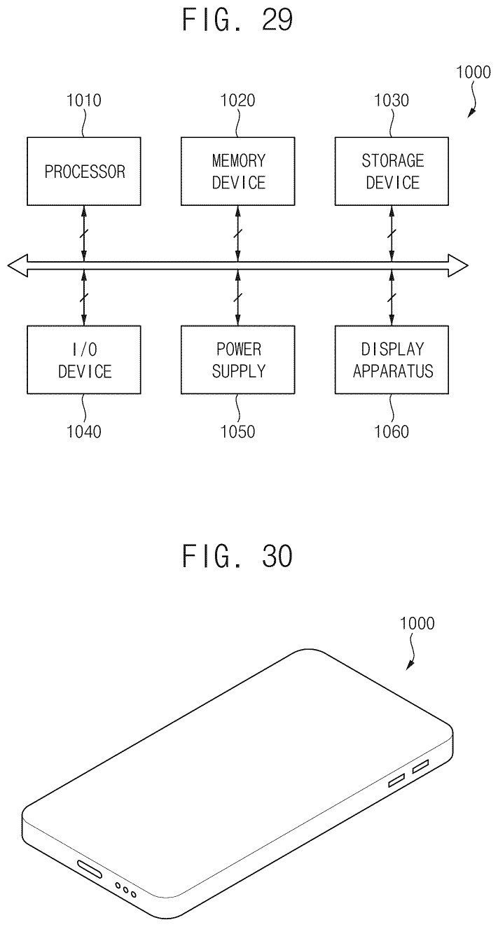

FIG. 29 is a block diagram illustrating an electronic apparatus 1000 according to an embodiment of the invention. FIG. 30 is a diagram illustrating an example in which the electronic apparatus 1000 of FIG. 29 is implemented as a smart phone.

Referring to FIGS. 29 and 30, an embodiment of the electronic apparatus 1000 may include a processor 1010, a memory device 1020, a storage device 1030, an input/output (I/O) device 1040, a power supply 1050, and a display apparatus 1060. Here, the display apparatus 1060 may be the display apparatus of FIG. 1. In addition, the electronic apparatus 1000 may further include a plurality of ports for communicating with a video card, a sound card, a memory card, a universal serial bus (USB) device, other electronic apparatuses, etc.

In an embodiment, as illustrated in FIG. 30, the electronic apparatus 1000 may be implemented as a smart phone. However, the electronic apparatus 1000 is not limited thereto. For example, the electronic apparatus 1000 may be implemented as a cellular phone, a video phone, a smart pad, a smart watch, a tablet computer, a car navigation system, a computer monitor, a laptop, a head mounted display (HMD) device, or the like.

The processor 1010 may perform various computing functions or various tasks. The processor 1010 may be a micro-processor, a central processing unit (CPU), an application processor (AP), or the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic apparatus 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, or the like and/or at least one volatile memory device such as a dynamic random access memory (DRAM) device, a static random access memory (SRAM) device, a mobile DRAM device, or the like.

The storage device 1030 may include a solid state drive (SSD) device, a hard disk drive (HDD) device, a CD-ROM device, or the like. The I/O device 1040 may include an input device such as a keyboard, a keypad, a mouse device, a touch-pad, a touch-screen, or the like and an output device such as a printer, a speaker, or the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

According to the embodiments of the gate signal masking circuit, the gate driver, the display apparatus and the electronic apparatus, the power consumption of the display apparatus may be reduced.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A gate signal masking circuit comprising:
a first switching element including a control electrode connected to a masking control node, a first electrode connected to a first control node and a second electrode connected to a third control node;
a second switching element including a control electrode connected to a second control node, a first electrode which receives a masking power signal and a second electrode connected to a first intermediate node;
a third switching element including a control electrode which receives a first enable signal, a first electrode connected to the first intermediate node and a second electrode connected to the masking control node;
a fourth switching element including a control electrode which receives a second enable signal, a first electrode connected to the masking control node and a second electrode connected to a second intermediate node; and
a fifth switching element including a control electrode connected to the second control node, a first electrode connected to the second intermediate node and a second electrode which receives a second low power voltage.

2. The gate signal masking circuit of claim 1, further comprising:
a sixth switching element including a control electrode connected to the third control node, a first electrode which receives a first clock signal and a second electrode connected to a gate output node;
a seventh switching element including a control electrode connected to the second control node, a first electrode connected to the gate output node and a second electrode which receives a low power voltage; and
an eighth switching element including a control electrode connected to the second control node, a first electrode which receives the first clock signal and a second electrode connected to the third control node.

3. The gate signal masking circuit of claim 2, wherein the second low power voltage is less than the low power voltage.

4. The gate signal masking circuit of claim 2, further comprising:
a first masking capacitor including a first electrode which receives the first clock signal and a second electrode connected to the third control node; and
a second masking capacitor including a first electrode connected to the masking control node and a second electrode which receives the low power voltage.

5. The gate signal masking circuit of claim 1, wherein the masking power signal is a high power voltage which is a direct-current voltage.

6. The gate signal masking circuit of claim 5, wherein a high level of the first enable signal is substantially the same as a high level of the second enable signal, and
wherein a low level of the first enable signal is different from a low level of the second enable signal.

7. The gate signal masking circuit of claim 6, wherein the high level of the first enable signal is the high power voltage and the low level of the first enable signal is a low power voltage greater than the second low power voltage, and
wherein the high level of the second enable signal is the high power voltage and the low level of the second enable signal is the second low power voltage.

8. The gate signal masking circuit of claim 6, wherein the high level of the first enable signal is the high power voltage and the low level of the first enable signal is a low power voltage greater than the second low power voltage, and
wherein the high level of the second enable signal is the high power voltage and the low level of the second enable signal is a third low power voltage different from the low power voltage and the second low power voltage.

9. The gate signal masking circuit of claim 5, wherein a high level of the first enable signal is the high power voltage and a low level of the first enable signal is the second low power voltage, and
wherein a high level of the second enable signal is the high power voltage and a low level of the second enable signal is the second low power voltage.

10. The gate signal masking circuit of claim 5, wherein a high level of the first enable signal is the high power voltage and a low level of the first enable signal is a third low power voltage different from the second low power voltage, and
wherein a high level of the second enable signal is the high power voltage and a low level of the second enable signal is the third low power voltage.

11. The gate signal masking circuit of claim 1, wherein the first switching element further includes an additional control electrode connected to the masking control node.

12. The gate signal masking circuit of claim 1, wherein the fifth switching element further includes an additional control electrode connected to the second control node.

13. The gate signal masking circuit of claim 1, wherein the masking power signal is a clock signal having a high level when the first enable signal changes from an active level to an inactive level and when the first enable signal changes from the inactive level to the active level.

14. The gate signal masking circuit of claim 1, wherein when the first enable signal has an inactive level in all periods in which a signal of the second control node has an active level, the gate signal masking circuit outputs a gate pulse.

15. The gate signal masking circuit of claim 1, wherein when the first enable signal has an active level in all periods in which a signal of the second control node has an active level, the gate signal masking circuit does not output a gate pulse.

16. The gate signal masking circuit of claim 1, wherein when the first enable signal is changed from an inactive level to an active level during a period in which a signal of the second control node has an active level, the gate signal masking circuit outputs a gate pulse.

17. The gate signal masking circuit of claim 1, wherein when the first enable signal is changed from an active level to an inactive level during a period in which a signal of the second control node has an active level, the gate signal masking circuit does not output a gate pulse.

18. A gate driver comprising:
a carry generator which generates a carry signal based on a previous carry signal, a first clock signal, a second clock signal and a low power voltage; and
a gate signal masking circuit connected to the carry generator,
wherein the carry generator comprises:
a pull-up switching element which pulls up the carry signal in response to a signal of a first control node; and
a pull-down switching element which pulls down the carry signal in response to a signal of a second control node, and
wherein the gate signal masking circuit outputs a gate pulse or does not output the gate pulse based on the signal of the second control node, a first enable signal and a second enable signal.

19. The gate driver of claim 18, wherein the gate signal masking circuit comprises:
a first switching element including a control electrode connected to a masking control node, a first electrode connected to the first control node and a second electrode connected to a third control node;
a second switching element including a control electrode connected to the second control node, a first electrode which receives a masking power signal and a second electrode connected to a first intermediate node;
a third switching element including a control electrode which receives the first enable signal, a first electrode connected to the first intermediate node and a second electrode connected to the masking control node;
a fourth switching element including a control electrode which receives the second enable signal, a first electrode connected to the masking control node and a second electrode connected to a second intermediate node; and
a fifth switching element including a control electrode connected to the second control node, a first electrode connected to the second intermediate node and a second electrode which receives a second low power voltage.

20. The gate driver of claim 19, wherein the carry generator comprises:
a first gate switching element including a control electrode which receives the first clock signal, a first electrode which receives the previous carry signal and a second electrode connected to a first node;
a second gate switching element including a control electrode connected to the second control node, a first electrode which receives the second clock signal and a second electrode connected to a fifth node;
a third gate switching element including a control electrode which receives the first clock signal, a first electrode connected to a second node and a second electrode which receives the low power voltage;
a fourth gate switching element including a control electrode which receives the low power voltage, a first electrode connected to the second node and a second electrode connected to a third node;
a fifth gate switching element including a control electrode connected to the second control node, a first electrode which receives the first clock signal and a second electrode connected to the second node;
a sixth gate switching element including a control electrode connected to the third node, a first electrode which receives the second clock signal and a second electrode connected to a third intermediate node;
a seventh gate switching element including a control electrode connected to the third node, a first electrode connected to a fourth node and a second electrode connected to the third intermediate node;
an eighth gate switching element including a control electrode which receives the second clock signal, a first electrode connected to the fourth node and a second electrode connected to the first control node;
a ninth gate switching element including a control electrode connected to the first control node, a first electrode which receives the first clock signal and a second electrode connected to a carry output node;
a tenth gate switching element including a control electrode connected to the second control node, a first electrode connected to the carry output node and a second electrode which receives the low power voltage;
an eleventh gate switching element including a control electrode which receives the low power voltage, a first electrode connected to the first node and a second electrode connected to the second control node; and
a fourteenth gate switching element including a control electrode connected to the second control node, a first electrode which receives the first clock signal and a second electrode connected to the first control node,
wherein the ninth gate switching element is the pull-up switching element, and
wherein the tenth gate switching element is the pull-down switching element.

21. The gate driver of claim 20, wherein the carry generator further comprises:
a twelfth gate switching element including a control electrode which receives a reset signal, a first electrode which receives the first clock signal and a second electrode connected to the first node; and
a thirteenth gate switching element including a control electrode which receives the reset signal, a first electrode connected to the first control node and a second electrode connected to the low power voltage.

22. The gate driver of claim 20, wherein the carry generator further comprises:
a first capacitor including a first electrode which receives the first clock signal and a second electrode connected to the first control node;
a second capacitor including a first electrode connected to the third node and a second electrode connected to the fourth node;
a third capacitor including a first electrode connected to the fifth node and a second electrode connected to the second control node; and
a fourth capacitor including a first electrode connected to the carry output node and a second electrode which receives the low power voltage.

23. The gate driver of claim 20, wherein the control electrode of the tenth gate switching element and the control electrode of the fourteenth gate switching element are connected to the control electrode of the seventh switching element and the control electrode of the eighth switching element.

24. The gate driver of claim 20, wherein the control electrode of the ninth gate switching element is connected to the first electrode of the first switching element.

25. A display apparatus comprising:
a display panel including a pixel;
a gate driver which outputs a gate signal to the pixel; and
a data driver which outputs a data voltage to the pixel,
wherein the gate driver comprises:
a carry generator which generates a carry signal based on a previous carry signal, a first clock signal, a second clock signal and a low power voltage; and
a gate signal masking circuit connected to the carry generator,
wherein the carry generator comprises:
a pull-up switching element which pulls up the carry signal in response to a signal of a first control node; and
a pull-down switching element which pulls down the carry signal in response to a signal of a second control node, and
wherein the gate signal masking circuit outputs a gate pulse or does not output the gate pulse based on the signal of the second control node, a first enable signal and a second enable signal.

26. An electronic apparatus comprising:
a display panel including a pixel;
a gate driver which outputs a gate signal to the pixel;
a data driver which outputs a data voltage to the pixel;
a driving controller which controls the gate driver and the data driver; and
a processor which outputs input image data and an input control signal to the driving controller,
wherein the gate driver comprises:
a carry generator which generates a carry signal based on a previous carry signal, a first clock signal, a second clock signal and a low power voltage; and
a gate signal masking circuit connected to the carry generator,
wherein the carry generator comprises:
a pull-up switching element which pulls up the carry signal in response to a signal of a first control node; and
a pull-down switching element which pulls down the carry signal in response to a signal of a second control node, and
wherein the gate signal masking circuit outputs a gate pulse or does not output the gate pulse based on the signal of the second control node, a first enable signal and a second enable signal.
